(19) United States
(12) Patent Application Publication
(10) Pub. No.: US 2014/0324380 A1
(43) Pub. Date: Oct. 30, 2014

(54) INFORMATION PROCESSING APPARATUS AND COOLING PERFORMANCE EVALUATION METHOD

(71) Applicant: FUJITSU LIMITED, Kawasaki-shi (JP)

(72) Inventors: Akihiro Otsuka, Yokohama (JP); Masaru Sugie, Hino (JP); Tadashi Katsui, Kawasaki (JP); Akira Ueda, Yokohama (JP); Atsushi Yamaguchi, Kawasaki (JP); Hiroyuki Furuya, Kawasaki (JP); Kazuhiro Nitta, Kawasaki (JP)

(73) Assignee: FUJITSU LIMITED, Kawasaki-shi (JP)

(21) Appl. No.: 14/250,813

(22) Filed: Apr. 11, 2014

(30) Foreign Application Priority Data
Apr. 25, 2013 (JP) 2013-092492

(51) Int. Cl. G01M 99/00

(52) U.S. Cl. CPC G01M 99/002
USPC 702/136

(57) ABSTRACT

A calculating unit calculates, using information indicating temperatures of a fluid mixture at individual locations across a space, heat quantities transferred to the fluid mixture at the individual locations. The fluid mixture is a blend of a plurality of fluids allowed to flow in by a plurality of cooling apparatuses. The calculating unit calculates heat quantities transferred to each of the fluids at the individual locations based on the heat quantities transferred to the fluid mixture at the individual locations, a velocity distribution of the fluid mixture, and flow rate distributions of the individual fluids. The calculating unit evaluates, using the heat quantities transferred to each of the fluids at the individual locations, the degree of contribution of each of the cooling apparatuses to cooling of an object disposed in the space.

### CROSS-REFERENCE TO RELATED APPLICATION

This application is based upon and claims the benefit of priority of the prior Japanese Patent Application No. 2013-092492, filed on Apr. 25, 2013, the entire contents of which are incorporated herein by reference.

### FIELD

The embodiments discussed herein are related to an information processing apparatus and a cooling performance evaluation method.

### BACKGROUND

Electronic components are now installed in various sorts of products. Such an electronic component consumes power and produces heat during its operation. The heating power may increase, for example, depending on the power consumption and the density of the arrangement of electronic components. Accumulation of heat in a chassis of a product may raise the temperature inside the chassis. An increase in the temperature of such a product could cause a failure, injury to the user, ignition or the like. Therefore, in the product development, products are designed in consideration of countermeasures against heat to thereby improve the reliability and safety of the products.

For example, as a method of cooling a heating element, such as an electronic component, it is considered to expose the heating element to a fluid such as a gas or liquid so that the fluid absorbs heat from the heating element. By transferring away the fluid having absorbed heat and continuing to expose the heating element to cold fluid, heat is continuously removed from the heating element. In some cases, a fan is used to cool air inside a product. Releasing air into a chassis of the product and discharging air from the chassis by a fan causes air to flow into the chassis from the outside, which generates convection to dissipate heat. To verify such heat dissipation with a fluid, thermal fluid analysis using a method called Computational Fluid Dynamics or CFD may be used.

In CFD analyses, a basic equation group called advection-diffusion equations is used. Space is discretized using, for example, the difference method, the finite volume method, or the finite element method, and the advection-diffusion equations are numerically solved under conditions in which heat dissipation is desired to be examined. This allows evaluation and verification of fluid advection and heat diffusion. For example, there has been proposed a technique of using visualized airflow and temperature distribution obtained as results of CFD analysis in order to verify a heat dissipation structure.

HARA et al., “Development/Practical Application of Thermal Hydraulic Analysis Technology and Heat Design (Effective Utilization for AVN Heat Design)”, [Online] Fujitsu Ten Limited, December 2006. Available from: www.fujitsu-ten.co.jp/gihou/jp_pdf/48/48-4.pdf. [Accessed: 25 May 2012].

ZHANG et al., “Development of the Time Response Model of the Contribution Ratio of Indoor Climate and Coupling to Energy Simulation (Part 2): Application of CRI to analyze the heat transfer characteristics in natural convection”, Summaries of technical papers of Annual Meeting Architectural Institute of Japan (Hokuriku). National University Corporation Tokyo University, September 2010.

Japanese Laid-open Patent Publication No. 2002-373181

Japanese Laid-open Patent Publication No. 2007-52029

In some cases, a plurality of cooling apparatuses (for example, fans) for allowing fluids to flow into a space are used. In such a situation, it is sometimes desired to comprehend, at a designing stage, the cooling performance of each of the cooling apparatuses when they are made to operate in parallel with each other. This is, for example, when a design is made to control the operation of the individual cooling apparatuses in order to save power consumption. However, the conventional thermal fluid analyses described above have not taken into account the evaluation of the cooling performance of each of the plurality of cooling apparatuses.

### SUMMARY

According to one embodiment, there is provided a computer-readable storage medium storing a computer program for evaluating cooling performance of each of a plurality of cooling apparatuses that allows a fluid for cooling an object disposed in a space to flow into the space. The computer program causes a computer to perform a procedure including calculating, using information indicating temperatures of a fluid mixture at individual locations across the space, heat quantities transferred to the fluid mixture at the individual locations, the fluid mixture being a blend of a plurality of fluids allowed to flow in by the cooling apparatuses; calculating heat quantities transferred to each of the fluids at the individual locations based on the heat quantities transferred to the fluid mixture at the individual locations, information indicating velocities of the fluid mixture at the individual locations, and information indicating flow rates of each of the fluids at the individual locations; and evaluating, using the heat quantities transferred to each of the fluids at the individual locations, the degree of contribution of each of the cooling apparatuses to cooling of the object.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus according to a first embodiment;

FIG. 2 illustrates an example of hardware of an evaluation apparatus according to a second embodiment;

FIG. 3 illustrates an example of software of the evaluation apparatus;

FIG. 4 illustrates an example of definition information;

FIGS. 5A and 5B illustrate an example of an analysis object model;

FIG. 6 illustrates an example of cell arrangement;

FIG. 7 is a flowchart illustrating an example of a process for cooling performance evaluation;

FIG. 8 illustrates a velocity distribution of mixed air;

FIG. 9 illustrates a first example of a flow rate distribution;

FIG. 10 illustrates a second example of the flow rate distribution;

FIG. 11 illustrates a third example of the flow rate distribution;

FIG. 12 illustrates an example of a temperature distribution of the mixed air;

FIG. 13 illustrates an example of a transferred heat quantity distribution;

FIG. 14 illustrates a first example of a fan-specific transferred heat quantity distribution (with initial values);

FIG. 15 illustrates a second example of the fan-specific transferred heat quantity distribution (with initial values);

FIG. 16 illustrates a third example of the fan-specific transferred heat quantity distribution (with initial values);

FIG. 17 illustrates a first example of a fan-specific potential heat quantity distribution (with initial values);

FIG. 18 illustrates a second example of the fan-specific potential heat quantity distribution (with initial values);

FIG. 19 illustrates a third example of the fan-specific potential heat quantity distribution (with initial values);

FIG. 20 is a flowchart illustrating an example of a process for updating fan-specific transferred heat quantity distributions;

FIGS. 21A, 21B, and 21C illustrate transferred heat and inflow heat of a cell;

FIGS. 22A and 22B illustrate an example of potential heat quantities and transferred heat quantities of the cell;

FIG. 23 illustrates an example of inflow heat quantities and updated potential heat quantities of the cell;

FIG. 24 illustrates an example of an update of the transferred heat quantities of the cell;

FIG. 25 illustrates a first example of a fan-specific transferred heat quantity distribution (after convergence);

FIG. 26 illustrates a second example of the fan-specific transferred heat quantity distribution (after convergence);

FIG. 27 illustrates a third example of the fan-specific transferred heat quantity distribution (after convergence);

FIG. 28 is a flowchart illustrating an example of a process for identifying cell ranges involved in heat transfer;

FIG. 29 illustrates an example of the cell ranges involved in the heat transfer;

FIG. 30 is a flowchart illustrating an example of a process for evaluating fan-specific cooling performance;

FIG. 31 illustrates a first example of an evaluation of the fan-specific cooling performance;

FIG. 32 illustrates a second example of the evaluation of the fan-specific cooling performance;

FIG. 33 illustrates a third example of the evaluation of the fan-specific cooling performance;

FIGS. 34A, 34B, and 34C illustrate a first set of display examples of evaluation results;

FIGS. 35A, 35B, 35C, 35D, and 35E illustrate a second set of display examples of the evaluation results; and

FIGS. 36A, 36B, 36C, and 36D illustrate a third set of display examples of the evaluation results.

### DESCRIPTION OF EMBODIMENTS

Several embodiments will be described below with reference to the accompanying drawings, wherein like reference numerals refer to like elements throughout.

### (a) First Embodiment

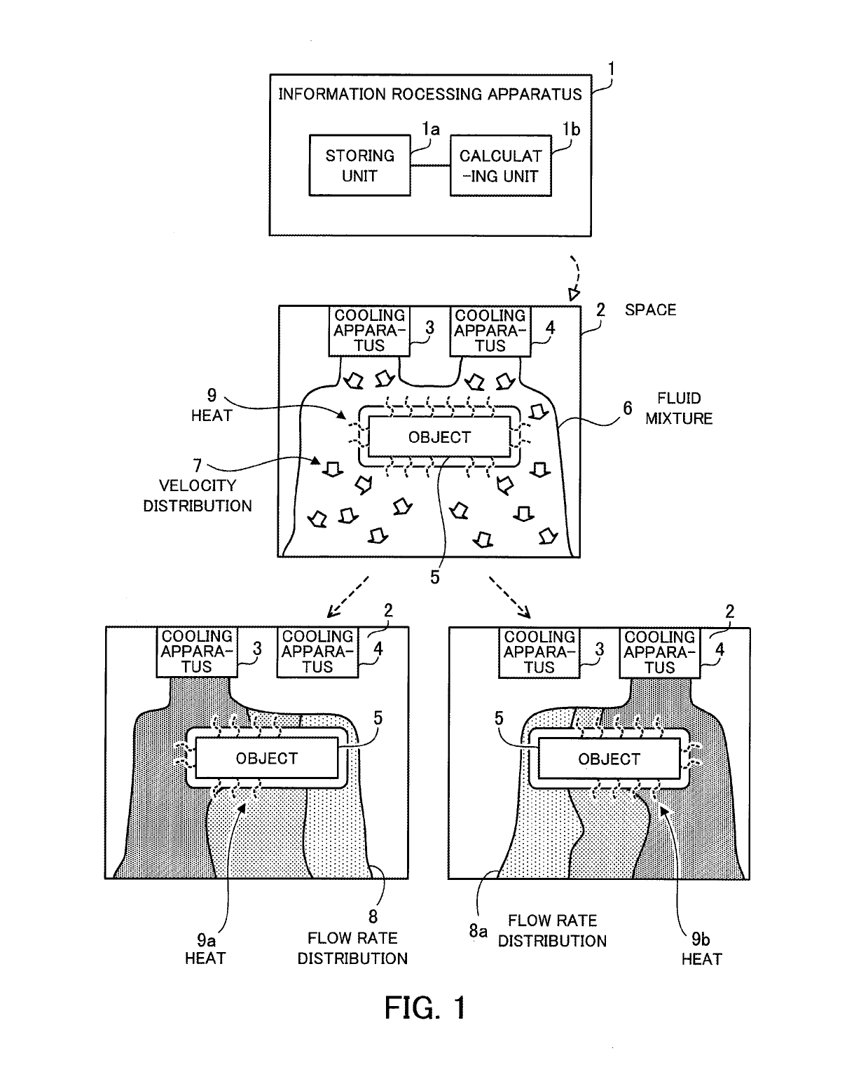

FIG. 1 illustrates an information processing apparatus according to a first embodiment. An information processing apparatus 1 is used to evaluate the cooling performance of individual cooling apparatuses. Each cooling apparatus allows a fluid for cooling an object disposed in a space to flow into the space. The fluid is a substance other than a solid, and may be a gas such as air or a liquid such as water, for example.

The cooling apparatus may introduce the fluid from the outside into a chassis, to thereby allow the fluid to flow into the space inside the chassis. Alternatively, the cooling apparatus may forcibly discharge the fluid inside the chassis to the outside, to thereby allow the fluid to flow into the chassis from the outside through a different inflow port. The cooling apparatus may be a blower to force a gas into the chassis (for example, a fan), or a liquid feeder to force a liquid into the chassis (for example, a pump).

The information processing apparatus 1 disposes a heating object and the cooling apparatuses in a virtual space and evaluates the cooling performance of each of the cooling apparatuses to cool the object. The information processing apparatus 1 includes a storing unit 1a and a calculating unit 1b. The storing unit 1a may be a storage device, such as a random access memory (RAM) and a hard disk drive (HDD). The calculating unit 1b may be a processor, such as a central processing unit (CPU) and a field programmable gate array (FPGA). Information processing according to the first embodiment may be achieved by the calculating unit 1b executing a program stored in the storing unit 1a. For example, the calculating unit 1b reads, from the storing unit 1a, information indicating a virtual space 2, information indicating cooling apparatuses 3 and 4, and information indicating a heating object 5, and creates a virtual verification environment in the information processing apparatus 1.

The storing unit 1a stores therein first information indicating temperatures of a fluid mixture 6 at individual locations across the space 2. The fluid mixture 6 is a blend of a plurality of fluids individually made to flow in by the cooling apparatuses 3 and 4 (here, two fluids, one made to flow in by the cooling apparatus 3 and the other made to flow in by the cooling apparatus 4; the same shall apply hereinafter). The plurality of fluids may be of the same type (for example, air in the case of a gas) or different types (for example, air and helium (He) in the case of gases).

The storing unit 1a stores therein second information indicating velocities of the fluid mixture 6 at the individual locations. The second information represents a velocity distribution 7, or a flow field, of the fluid mixture 6 across the space 2. The storing unit 1a stores therein third information indicating flow rates at the individual locations with respect to each of the plurality of fluids. The third information includes a flow rate distribution 8 of the fluid made to flow in by the cooling apparatus 3 and a flow rate distribution 8a of the fluid made to flow in by the cooling apparatus 4.

The first, second, and third information is acquired as results of thermal fluid analysis based on conventional CFD. For example, the calculating unit 1b may carry out in advance thermal fluid analysis using CFD for the case where the cooling apparatuses 3 and 4 are made to operate in parallel in the above-described virtual verification environment, to thereby acquire the first, second, and third information.

Using the first information stored in the storing unit 1a, the calculating unit 1b calculates the amount of heat transferred (hereinafter sometimes referred to as the ‘transferred heat quantity’) to the fluid mixture 6 at each of the individual locations. The transferred heat quantity of the fluid mixture 6 at each location represents a heat quantity gained (or removed) by the fluid mixture 6 at the location. For example, the transferred heat quantity of the fluid mixture 6 at each location is obtained by calculating, at a steady state (where there is no temporal change in each distribution), the divergence of the temperature gradient from the temperature distribution indicated by the first information. Specifically, the heat quantity (k·gradT) is obtained by multiplying the gradient of the temperature (T), (gradT), by the thermal conductivity (k) of the fluid, and the heat production or absorption per unit volume, or heat discharge per unit volume (i.e., the amount of heat transferred to a fluid), is obtained from the divergence of the heat quantity (div(k·gradT)).

Based on the transferred heat quantity of the fluid mixture 6 at each of the locations and the second and third information stored in the storing unit 1a, the calculating unit 1b calculates transferred heat quantities of each of the plurality of fluids, individually made to flow in by the cooling apparatuses 3 and 4, at the individual locations. Specifically, based on the flow rate distributions 8 and 8a, the transferred heat quantity of the fluid mixture 6 at each of the locations is prorated according to the flow ratio among the plurality of fluids at the location, to thereby estimate the transferred heat quantity of each of the plurality of fluids at the location.

Note however that the simple proration according to the flow ratio does not take into account the effect of the advection of the fluids individually made to flow in by the cooling apparatuses 3 and 4. Therefore, with respect to each of the cooling apparatuses 3 and 4, the distribution of the amount of heat (temperature) at the individual locations is updated by solving an advection equation using the individual locations as heat sources (i.e. using the transferred heat quantities at the individual locations as heating powers of the heat sources), to thereby adjust the transferred heat quantities at the individual locations with respect to each of the cooling apparatuses 3 and 4.

Specifically, the calculating unit 1b numerically solves the advection equation under steady-state conditions with no heat diffusion by plugging the velocity distribution 7 and the transferred heat quantity distribution of the cooling apparatus 3 into the advection equation, to thereby obtain a first potential heat quantity distribution, which is a distribution of the amount of heat stored in a first fluid made to flow in by the cooling apparatus 3. In addition, the calculating unit 1b numerically solves the advection equation under steady-state conditions with no heat diffusion by plugging the velocity distribution 7 and the transferred heat quantity distribution of the cooling apparatus 4 into the advection equation, to thereby obtain a second potential heat quantity distribution, which is a distribution of the amount of heat stored in a second fluid made to flow in by the cooling apparatus 4. Then, the calculating unit 1b updates the transferred heat quantities individually associated with the cooling apparatuses 3 and 4 at each of the locations (the total transferred heat quantities associated with the cooling apparatuses 3 and 4 at each of the locations are equal to the transferred heat quantity of the fluid mixture 6 at the location) in such a manner that two temperature distributions individually obtained based on the first and second potential heat quantity distributions become uniform (specifically, uniform with a predetermined error rate). By an iterative method, the update is repeated until the residual error of each of the first and second potential heat quantity distributions converges. In this manner, the transferred heat quantities individually associated with the cooling apparatuses 3 and 4 at each of the locations may be adjusted in consideration of the effect of the advection. Such an adjustment is made because it is considered that the first and the second fluids have reached almost the same temperature when flowing away from each of the locations.

Using the transferred heat quantities of each of the plurality of fluids at the individual locations, the calculating unit 1b evaluates the degree of contribution of each of the cooling apparatuses 3 and 4 to cooling of the object 5. For example, based on the transferred heat quantity distribution related to the first fluid made to flow in by the cooling apparatus 3, transferred heat quantities in a predetermined region around the object 5 are integrated to thereby evaluate a first heat quantity removed from the object 5 by the first fluid delivered by the cooling apparatus 3. In addition, based on the transferred heat quantity distribution related to the second fluid made to flow in by the cooling apparatus 4, transferred heat quantities in the predetermined region around the object 5 are integrated to thereby evaluate a second heat quantity removed from the object 5 by the second fluid delivered by the cooling apparatus 4. A comparison between the first and second heat quantities allows evaluating the degree of contribution of each of the cooling apparatuses 3 and 4 to cooling of the object 5.

In summary, according to the information processing apparatus 1, the calculating unit 1b calculates transferred heat quantities of the fluid mixture 6 at the individual locations across the space 2 (the transferred heat quantity distribution of the fluid mixture 6) using the first information indicating temperatures of the fluid mixture 6 at the individual locations. Then, based on the transferred heat quantity distribution of the fluid mixture 6, the second information indicating velocities of the fluid mixture 6 at the individual locations (the velocity distribution 7), and the third information indicating flow rates at the individual locations with respect to each of the plurality of fluids (the flow rate distributions 8 and 8a), the calculating unit 1b calculates transferred heat quantities of each of the plurality of fluids at the individual locations (the transferred heat quantity distributions related to the individual fluids). Using the transferred heat quantity distributions related to the individual fluids, the calculating unit 1b evaluates the degree of contribution of each of the cooling apparatuses 3 and 4 to cooling of the object 5.

This provides support for verification of the cooling performance of each of a plurality of cooling apparatuses. For example, a plurality of cooling apparatuses, such as fans, are provided in a chassis of a product in order to deal with an increase in temperature of the product. This is because the cooling performance is likely to be improved by an increase in flow rate of a fluid in a space inside the chassis. However, the product does not necessarily remain at a high temperature at all the time. For example, in the case of some products like computers, electronic components consume a measurable amount of power and produce a large amount of heat under relatively high load while consuming less power and producing a reduced amount of heat under relatively low load. Causing all the cooling apparatuses to operate in spite of the power consumption and the amount of heat generation being reduced leads to unnecessary power consumption for operating the cooling apparatuses.

For this reason, it may be desired to control the operation of each of the cooling apparatuses. For example, if the internal space of the chassis is maintained at a predetermined temperature by operating only some of the cooling apparatuses when the computer is under low load, the remaining cooling apparatuses are stopped to thereby save power consumption. Therefore, in order to examine how to control the cooling apparatuses, there are times when it is desired to comprehend the cooling performance of each of the plurality of cooling apparatuses at a designing stage.

However, in conventional thermal fluid analysis, it is difficult to calculate the cooling performance of each cooling apparatus when a plurality of cooling apparatuses are caused to operate in parallel. Fluids made to flow in by the plurality of cooling apparatuses are blended to create a single flow field. Therefore, simply solving the basic equations numerically by using the flow field only enables the evaluation of the total cooling performance of all the cooling apparatuses.

That is, the conventional thermal fluid analysis is able to evaluate the heat dissipation effect of the fluid mixture 6 with respect to heat 9 radiated by the object 5, however, not able to evaluate heat 9a removed from the object 5 by the inflow fluid delivered by the cooling apparatus 3 and heat 9b removed from the object 5 by the inflow fluid delivered by the cooling apparatus 4.

In view of this, the information processing apparatus 1 calculates a transferred heat quantity distribution for each of the plurality of fluids based on the following information: the transferred heat quantity distribution of the fluid mixture 6; the velocity distribution 7 of the fluid mixture 6; and the flow rate distributions 8 and 8a representing flow rates of the fluids, individually made to flow into the space 2 by the cooling apparatuses 3 and 4, respectively, at individual locations across the space 2. Then, based on the calculated transferred heat quantity distributions, the information processing apparatus 1 evaluates the cooling performance of each of the cooling apparatuses 3 and 4 to cool the object 5. In this manner, the evaluation of the cooling performance of the individual cooling apparatuses 3 and 4 to cool the object 5 is made possible without the understanding of the flow field specific to each of the fluids delivered into the space 2 by the cooling apparatuses 3 and 4 (it is difficult to comprehend the flow fields of a plurality of fluids because the fluids are blended to create a single flow field).

The information processing apparatus 1 may be configured to cause a display device to display, as results of the evaluation, heat quantities removed from the object 5 by the inflow fluids individually delivered by the cooling apparatuses 3 and 4 and ratios of each of the heat quantities to the heating power of the object 5. For example, a product developer is able to verify the cooling performance of each of a plurality of cooling apparatuses by reviewing such evaluation results. Specifically, while adjusting the flow rates of the individual cooling apparatuses, the product developer causes the information processing apparatus 1 to evaluate the cooling performance of the individual cooling apparatuses when they are made to operate in parallel with each other, to thereby design cooling apparatus-specific control (such as the operation and stop of each of the cooling apparatuses, and an increase or decrease in power consumption during the operation). In this manner, the information processing apparatus 1 provides support for efficient verification of the cooling performance of each of the plurality of cooling apparatuses.

### (b) Second Embodiment

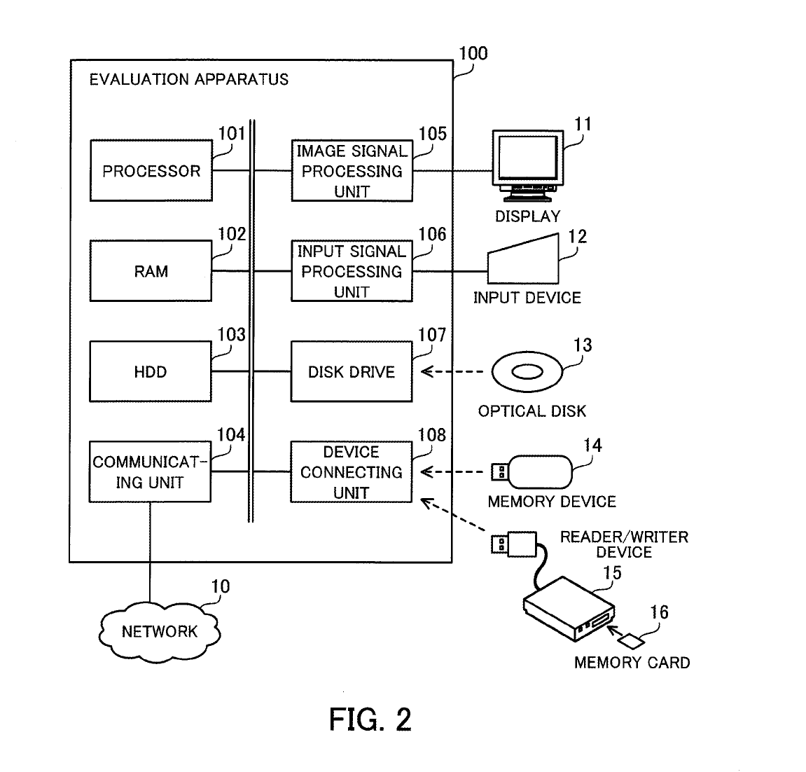

FIG. 2 illustrates an example of hardware of an evaluation apparatus according to a second embodiment. An evaluation apparatus 100 is a computer for thermal fluid analysis using CFD. The evaluation apparatus 100 includes a processor 101, a RAM 102, a HDD 103, a communicating unit 104, an image signal processing unit 105, an input signal processing unit 106, a disk drive 107, and a device connecting unit 108. The individual units are connected to a bus of the evaluation apparatus 100.

The processor 101 controls information processing of the evaluation apparatus 100. The processor 101 may be a multi-processor. The processor 101 is, for example, a CPU, a micro processing unit (MPU), a digital signal processor (DSP), an application specific integrated circuit (ASIC), a FPGA, a programmable logic device (PLD), or a combination of two or more of these.

The RAM 102 is used as a main storage device of the evaluation apparatus 100. The RAM 102 temporarily stores at least part of an operating system (OS) program and application programs to be executed by the processor 101. The RAM 102 also stores therein various types of data to be used by the processor 101 for its processing.

The HDD 103 is a secondary storage device of the evaluation apparatus 100, and magnetically writes and reads data to and from a built-in disk. The HDD 103 stores therein the OS program, application programs, and various types of data. Instead of the HDD 103, the evaluation apparatus 100 may be provided with a different type of secondary storage device such as a flash memory and a solid state drive (SSD), or may be provided with a plurality of secondary storage devices.

The communicating unit 104 is an interface for communicating with other computers via a network 10. The communicating unit 104 may be a wired or wireless interface.

The image signal processing unit 105 outputs an image to a display 11 connected to the evaluation apparatus 100 according to an instruction from the processor 101. A cathode ray tube (CRT) display or a liquid crystal display, for example, may be used as the display 11.

The input signal processing unit 106 acquires an input signal from an input device 12 connected to the evaluation apparatus 100, and outputs the signal to the processor 101. A keyboard or a pointing device, such as a mouse and a touch panel, may be used as the input device 12.

The disk drive 107 is a drive unit for reading programs and data recorded on an optical disk 13 using, for example, laser light. Examples of the optical disk 13 include a digital versatile disc (DVD), a DVD-RAM, a compact disk read only memory (CD-ROM), a CD recordable (CD-R), and a CD-rewritable (CD-RW). According to an instruction from the processor 101, for example, the disk drive 107 stores the programs and data read from the optical disk 13 in the RAM 102 or the HDD 103.

The device connecting unit 108 is a communication interface for connecting peripherals to the evaluation apparatus 100. For example, a memory device 14 and a reader/writer device 15 may be connected to the device connecting unit 108. The memory device 14 is a recording medium provided with a function of communicating with the device connecting unit 108. The reader/writer device 15 writes and reads data to and from a memory card 16, which is a card type recording medium. According to an instruction from the processor 101, for example, the device connecting unit 108 stores programs and data read from the memory device 14 or the memory card 16 in the RAM 102 or the HDD 103.

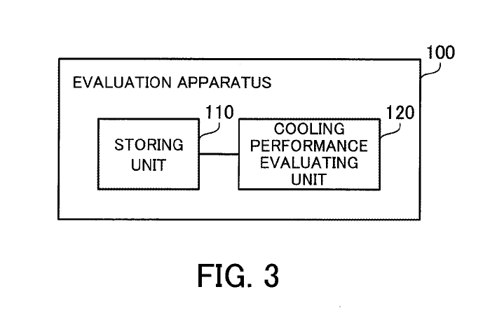

FIG. 3 illustrates an example of software of an evaluation apparatus. The evaluation apparatus 100 includes a storing unit 110 and a cooling performance evaluating unit 120. The storing unit 110 may be implemented with the use of a storage area of the RAM 102 or the HDD 103. The cooling performance evaluating unit 120 may be implemented when the processor 101 executes a program stored in the storing unit 110.

The storing unit 110 stores various types of information used by the cooling performance evaluating unit 120 for its processing. For example, the storing unit 110 stores therein definition information which is information defining an analysis object model of thermal fluid analysis.

Based on the information stored in the storing unit 110, the cooling performance evaluating unit 120 evaluates the cooling performance of a cooling apparatus, such as a fan, to cool a heating element. Note that the analysis object model may include a plurality of cooling apparatuses. The cooling performance evaluating unit 120 evaluates the overall cooling performance of all the cooling apparatuses by a CFD method. Further, the cooling performance evaluating unit 120 evaluates the cooling performance of each of the cooling apparatuses to cool the heating element.

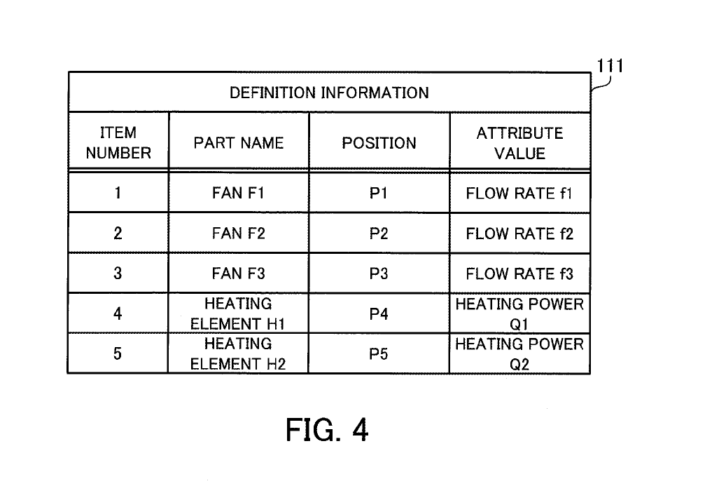

FIG. 4 illustrates an example of definition information. Definition information 111 is prestored in the storing unit 110. The definition information 111 includes columns for individual data items of item number; part name; position; and attribute value. In the item number column, each entry contains a number for identifying a record. In the part name column, each entry contains the name of a part disposed in a space of the analysis object model. In the position column, each entry contains information indicating a position within the space, at which a corresponding part is disposed. In the attribute value column, each entry contains an attribute value specific to a corresponding part. For example, the attribute value is the flow rate when the corresponding part is a fan, and the attribute value is the heating power when the corresponding part is a heating element.

For example, a record with the item number ‘1’, the part name ‘fan F1’, the position ‘P1’, and the attribute value ‘flow rate f1’ is registered in the definition information 111. This record indicates that the fan F1 is disposed at the position P1 within the model space and has the flow rate f1. The unit of flow rate is the cubic meter per second (m³/s). Similarly, records with the item numbers ‘2’ and ‘3’ indicate information of fans F2 and F3, respectively. The attribute values of the fans F2 and F3 are flow rates f2 and f3, respectively.

In the following description, the flow rate of a fan means the volume of a fluid released by the fan into the space for the analysis. In addition, it is assumed here that the fluid is air. Note however that a different type of fluid may be used, or alternatively, a liquid may be used as the fluid.

For example, a record with the item number ‘4’, the part name ‘heating element H1’, the position ‘P4’, and the attribute value ‘heating power Q1’ is registered in the definition information 111. This record indicates that the heating element H1 (for example, an object equivalent of an electronic component) is disposed at the position P4 within the model space and has the heating power Q1. Similarly, a record with the item number ‘5’ indicates information of a heating element H2, whose attribute value is ‘heating power Q2’. In the following description, the heating power is expressed in Watts (W) (power consumed per unit time).

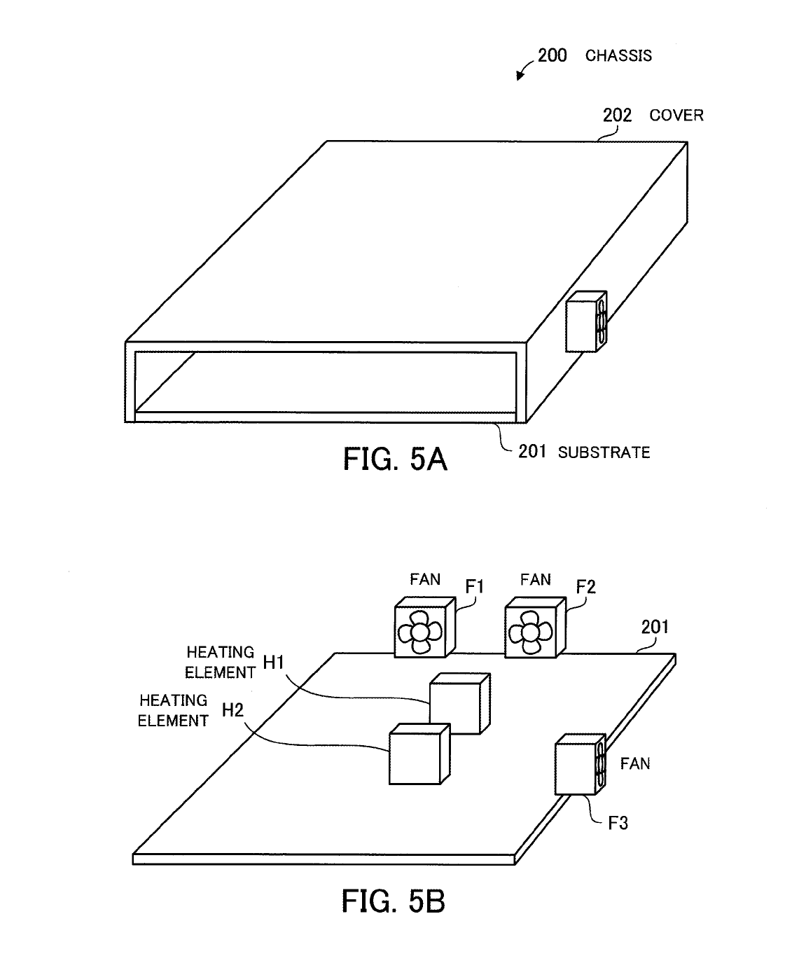

FIGS. 5A and 5B illustrate an example of an analysis object model. FIG. 5A illustrates an example of an external appearance of a chassis 200 targeted for the analysis. The chassis 200 includes a substrate 201 and a cover 202. The substrate 201 is a member on which parts are disposed. The cover 202 covers the upper surface of the substrate 201 with walls in contact with the substrate 201 and another wall (forming a ceiling) disposed at a distance from the substrate 201 in such a manner as to create a space defined by the substrate 201 and the cover 202. A side of the chassis 200 at the front of FIG. 5A is open, and a side of the chassis 200 at the rear of FIG. 5A is closed. The space formed by the substrate 201 and the cover 202 is referred to as an internal space of the chassis 200. Note however that the internal space of the chassis 200 communicates with the outside of the chassis 200 via the opening.

FIG. 5B illustrates the chassis 200 with the cover 202 having been removed. On the substrate 201, the fans F1, F2, and F3 and the heating elements H1 and H2 are disposed. The positions and the attribute values of the fans F1, F2, and F3 and the heating elements H1 and H2 are defined by the definition information 111, as mentioned above. The cover 202 is provided with holes at positions corresponding to the fans F1, F2, and F3 so that the fans F1, F2, and F3 are able to take in air from the outside of the chassis 200 and release the air into the internal space of the chassis 200. That is, the air released into the internal space of the chassis 200 by the fans F1, F2, and F3 flows inside the chassis 200 toward the opening at the front of FIG. 5A. In doing so, the air released by the fans F1, F2, and F3 absorbs heat radiated from the heating elements H1 and H2 and carries away the heat, thus cooling the heating elements H1 and H2.

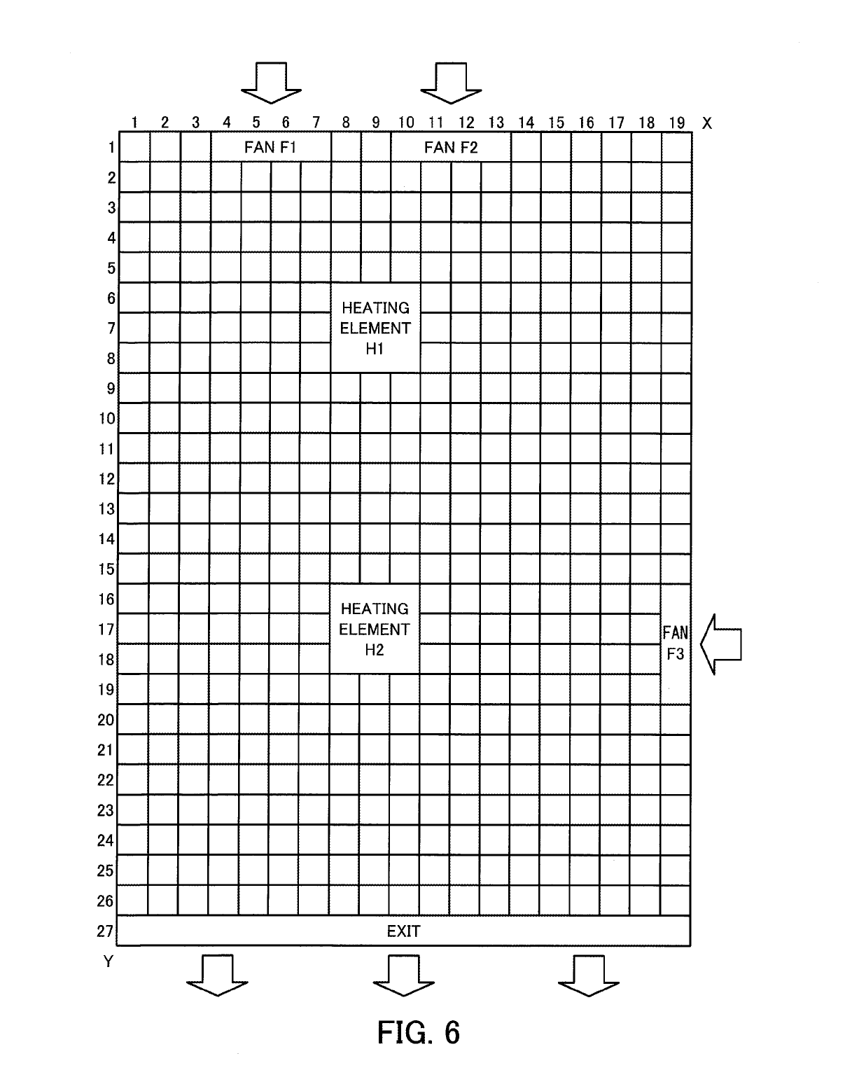

FIG. 6 illustrates an example of cell arrangement. Locations across the internal space of the chassis 200 are defined by cells formed by dividing the top surface of the substrate 201 into a grid. For example, the origin is set at the upper-left corner of FIG. 6, and the X- and Y-axes lie in the horizontal and vertical directions, respectively, in FIG. 6. Locations of 19×26 cells are managed by dividing the X- and Y-axes into 19 and 26 equally spaced intervals, respectively. The size of the unit cell may be optionally changed, and the internal space of the chassis 200 may be divided into even smaller cells, for example. Cell coordinates are expressed as ‘(X, Y)’ (in the following figures, the notation of ‘(X, Y)’ is omitted). Cells at Y=27 form an exit of air inside the chassis 200.

For example, the position P1 of the fan F1 is defined by {(4, 1), (5, 1), (6, 1), (7, 1)}. The position P2 of the fan F2 is defined by {(10, 1), (11, 1), (12, 1), (13, 1)}. The position P3 of the fan F3 is defined by {(19, 16), (19, 17), (19, 18), (19, 19)}. For example, the position P4 of the heating element H1 is defined by {(8, 6), (9, 6), (10, 6), (8, 7), (9, 7), (10, 7), (8, 8), (9, 8), (10, 8)}. The position P5 of the heating element H2 is defined by {(8, 16), (9, 16), (10, 16), (8, 17), (9, 17), (10, 17), (8, 18), (9, 18), (10, 18)}.

As described above, air flows into the inside of the chassis 200 from the upper side of the fans F1 and F2 and the right side of the fan F3 in FIG. 6, and then flows out from the chassis 200 through the exit. Hereinafter, the term ‘mixed air’ is sometimes used to refer to a mixture of air formed after air is introduced into the chassis 200 by the individual fans F1, F2, and F3.

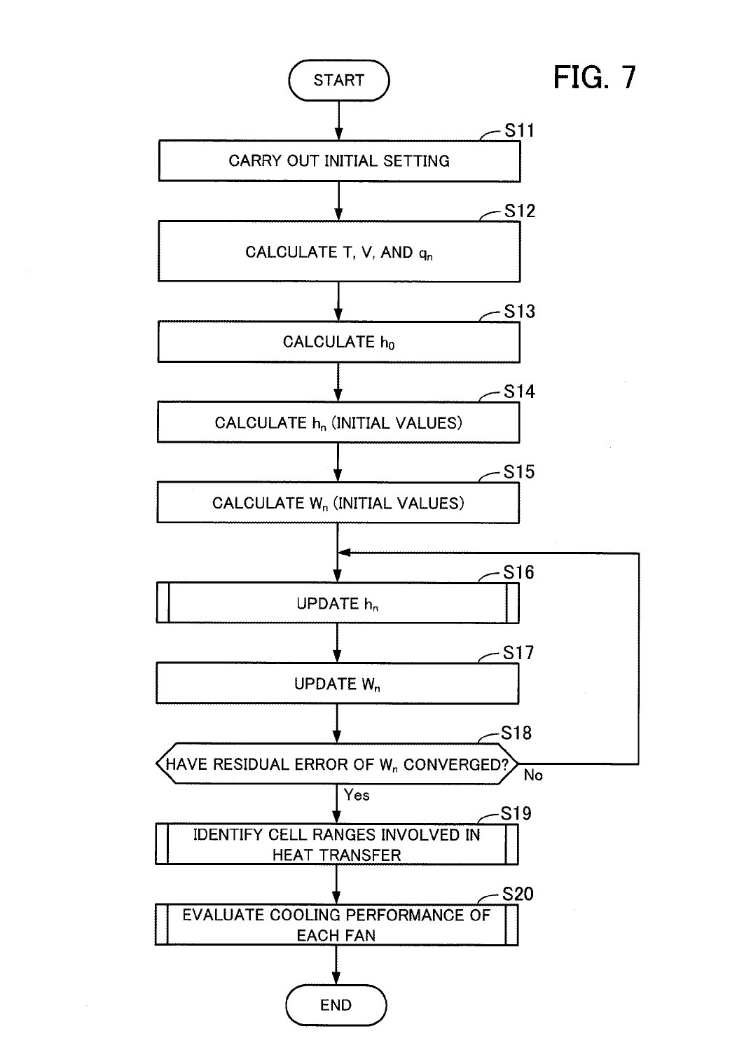

FIG. 7 is a flowchart illustrating an example of a process for cooling performance evaluation. The process of FIG. 7 is described next according to the step numbers in the flowchart.

(Step S11) With reference to the definition information 111 stored in the storing unit 110, the cooling performance evaluating unit 120 carries out an initial setting for thermal fluid analysis. Specifically, the cooling performance evaluating unit 120 reads information of the positions and the attribute values of the fans F1, F2, and F3 and the heating elements H1 and H2 provided in the chassis 200.

(Step S12) Using a conventional CFD method, the cooling performance evaluating unit 120 calculates a steady state temperature distribution (T(x)) of the mixed air inside the chassis 200, a velocity distribution (vector V(x)) of the mixed air, and an air flow rate distribution (qₙ(x)) associated with each fan. Here, vector x which is a variable of each of the distributions is a position vector x=(x, y, z) indicating a spatial position within the chassis 200 (z is constant). Note that the x-axis lies along the X-axis, and the y-axis lies along the Y-axis. Assume here that the degree of discretization (the unit cell size) is the same. The symbol n represents a fan among the fans F1, F2, and F3. The fans F1, F2, and F3 are denoted in equations as fan1, fan2, and fan3, respectively. T is in Kelvin (K), and vector V is in meter per second (m/s).

(Step S13) The cooling performance evaluating unit 120 calculates a transferred heat quantity distribution h₀(x) of the mixed air. The unit of h₀ is Watts (W). An advection-diffusion equation is expressed as Equation (1) below. Note that the notation of the position vector x is omitted from Equation (1) (it may also be omitted from the following description).

$$\frac{\partial }{\partial t} ( ρ E ) + ∇ \cdot ( {V}^{->} ( ρ E + p ) ) = ∇ \cdot k ∇ T + S \qquad ( 1 )$$

where t is the time (s), ρ is the density of air (kg/m³), E is the square of the velocity (m²/s²), ∇ (nabla) is a spatial vector differential operator, vector V is the velocity distribution of the mixed air, p is the pressure (Pa), k is the thermal conductivity of air (W/(m·K)), T is the temperature distribution, and S is the heating power density (W/m³). The first and second terms in the left-hand side of Equation (1) are sometimes referred to as the unsteady term and the advection term, respectively. The first and second terms in the right-hand side of Equation (1) are sometimes referred to as the heat transfer term and the heating power term (source term), respectively. Energy density ψ in joules per cubic meter (J/m³) is defined as Equation (2).

ψ(\vec{x})=ρE(\vec{x})+p(\vec{x}) (2)

Then, by incorporating steady-state conditions with no heat generation in each cell into Equation (1), the unsteady term and the heating power term are allowed to be ignored, and thereby Equation (3) below is obtained. The temperature distribution T obtained in step S12 is plugged into Equation (3) to thereby obtain the transferred heat quantity distribution h₀ (Equation (4)).

$$\begin{matrix}∇ \cdot ( {V}^{->} ψ ) = ∇ \cdot k ∇ T & ( 3 ) \\ = {a}^{- 1} {h}_{0} & ( 4 )\end{matrix}$$

where a is volume per cell (m³).

(Step S14) The cooling performance evaluating unit 120 calculates initial values of individual fan-specific transferred heat quantity distributions hₙ(x) using Equation (5). The unit of hₙ is Watts (W).

$$\begin{matrix}{h}_{n}^{( 0 )} ( {x}^{->} ) = {h}_{0} ( {x}^{->} ) \cdot \frac{{q}_{n} ( {x}^{->} )}{q ( {x}^{->} )} & ( 5 ) \\ = a {S}_{n}^{( 0 )} ( {x}^{->} ) & ( 6 )\end{matrix}$$

where qₙ is the air flow rate distribution associated with each fan obtained in step S12. Note that q equals Σqₙ (q=Σqₙ) where the symbol Σ means to sum n. The superscript in parentheses indicates the number of iterative calculations i (i is an integer greater than or equal to 0), and i=0, namely ‘(0)’, represents initial values. Note that the notation of the superscript ‘(i)’ may be omitted in the following description. According to Equation (6), each hₙ is converted to a corresponding transferred heat quantity density distribution Sₙ (Equation (6) may be used with any value of i). Since heat discharge may be viewed as heat generation, the case could be made that the transferred heat quantity density distribution Sₙ indicates air heating power density in each cell.

(Step S15) The cooling performance evaluating unit 120 calculates initial values of individual fan-specific potential heat quantity distributions Wₙ(x) using Equations (7) and (8). The unit of Wₙ is Watts (W).

∇·(\vec{V}ψₙ⁽ⁱ⁾)=Sₙ⁽ⁱ⁾ (7)

Wₙ⁽ⁱ⁾(\vec{x})=qₙ(\vec{x})·ψₙ⁽ⁱ⁾(\vec{x}) (8)

Here, i=0 since the initial values are to be obtained. Equation (7) is an advection equation formed by ignoring the unsteady term and the heat transfer term in Equation (1). This is because the focus is on the steady state and the interest here is in obtaining energy density distributions ψₙ, which give heat discharge (heat transfer) in each cell represented by the transferred heat quantity density distributions Sₙ when considered together with the advection of air caused by the velocity distribution V. The energy density distributions ψₙ may be referred to as distributions of potential energy density of each cell, attributable to the fluid delivered from each of the fans.

(Step S16) The cooling performance evaluating unit 120 updates the individual fan-specific transferred heat quantity distributions hₙ. That is, using each fan-specific transferred heat quantity distribution hₙ obtained in the i-th iteration, the cooling performance evaluating unit 120 calculates the i+1-th fan-specific transferred heat quantity distribution hₙ. The specific calculation method is described later. Note that each fan-specific transferred heat quantity distribution hₙ is converted to a corresponding transferred heat quantity density distribution Sₙ according to Equation (6).

(Step S17) The cooling performance evaluating unit 120 updates the individual fan-specific potential heat quantity distributions Wₙ using Equations (7) and (8). That is, each Wₙ is updated using a corresponding Sₙ updated in step S16.

(Step S18) The cooling performance evaluating unit 120 determines whether the residual error of each of the fan-specific potential heat quantity distributions Wₙ has converged. If the convergence has not been reached, the cooling performance evaluating unit 120 advances the process to step S16. If the convergence has been achieved, the cooling performance evaluating unit 120 advances the process to step S19.

(Step S19) The cooling performance evaluating unit 120 identifies a cell range involved in heat transfer with respect to each of the heating elements H1 and H2. Specifically, based on a predetermined rule, a predetermined cell range around the heating element H1 is extracted from the internal space of the chassis 200. Similarly, a predetermined cell range around the heating element H2 is extracted from the internal space of the chassis 200.

(Step S20) Using the transferred heat quantity distributions hₙ and the cell ranges extracted in step S19, the cooling performance evaluating unit 120 evaluates the cooling performance of each of the fans F1, F2, and F3 with respect to each of the heating elements H1 and H2. The cooling performance evaluating unit 120 causes the display 11 to display the evaluation results.

In the above-described manner, the cooling performance evaluating unit 120 updates the transferred heat quantity distributions hₙ until the residual error of each of the potential heat quantity distributions Wₙ converges, and uses the transferred heat quantity distributions hₙ obtained at the end to evaluate the cooling performance of each of the fans F1, F2, and F3 with respect to each of the heating elements H1 and H2.

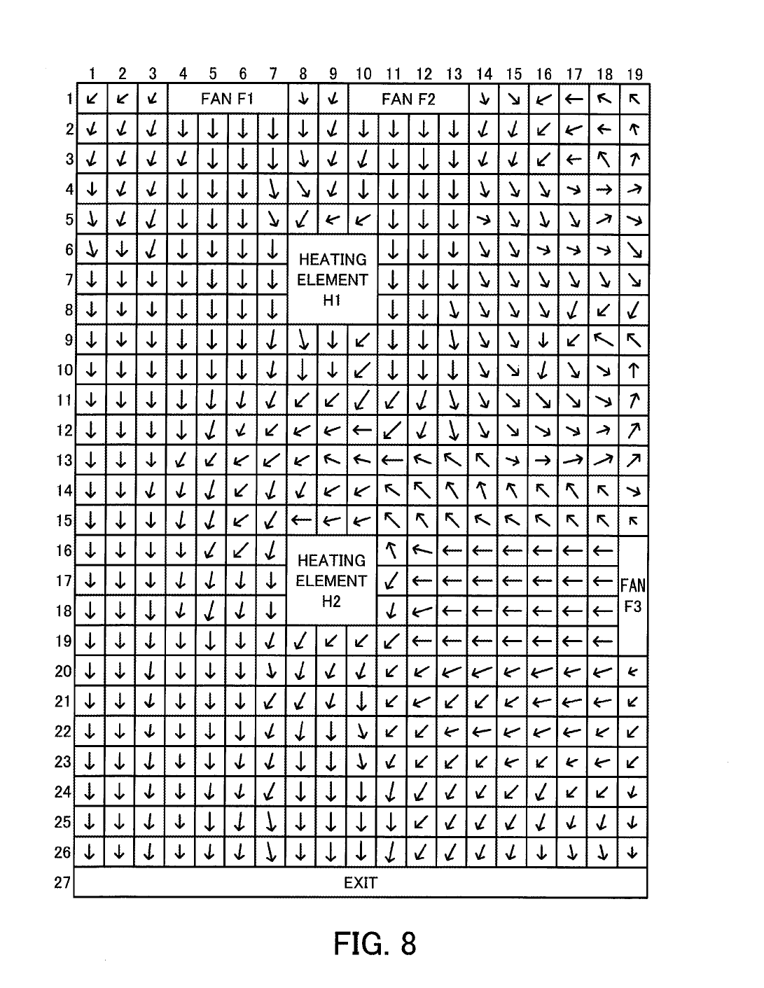

FIG. 8 illustrates a velocity distribution of mixed air. FIG. 8 exemplifies the velocity distribution V of the mixed air in a steady state at the time of all the fans F1, F2, and F3 being in operation. For example, air from the fan F1 and air from the fan F2 flow from the upper side to the lower side of FIG. 8 and blend together. Air from the fan F3 flows from right to left in FIG. 8. After hitting against the heating element H2, the air from the fan F3 migrates upward and downward in FIG. 8. The migrating air blasts the flow of air from the fans F1 and F2 causing the air from the fans F1, F2, and F3 to blend. The air from the fan F2 is more heavily affected by the blast than the air from the fan F1.

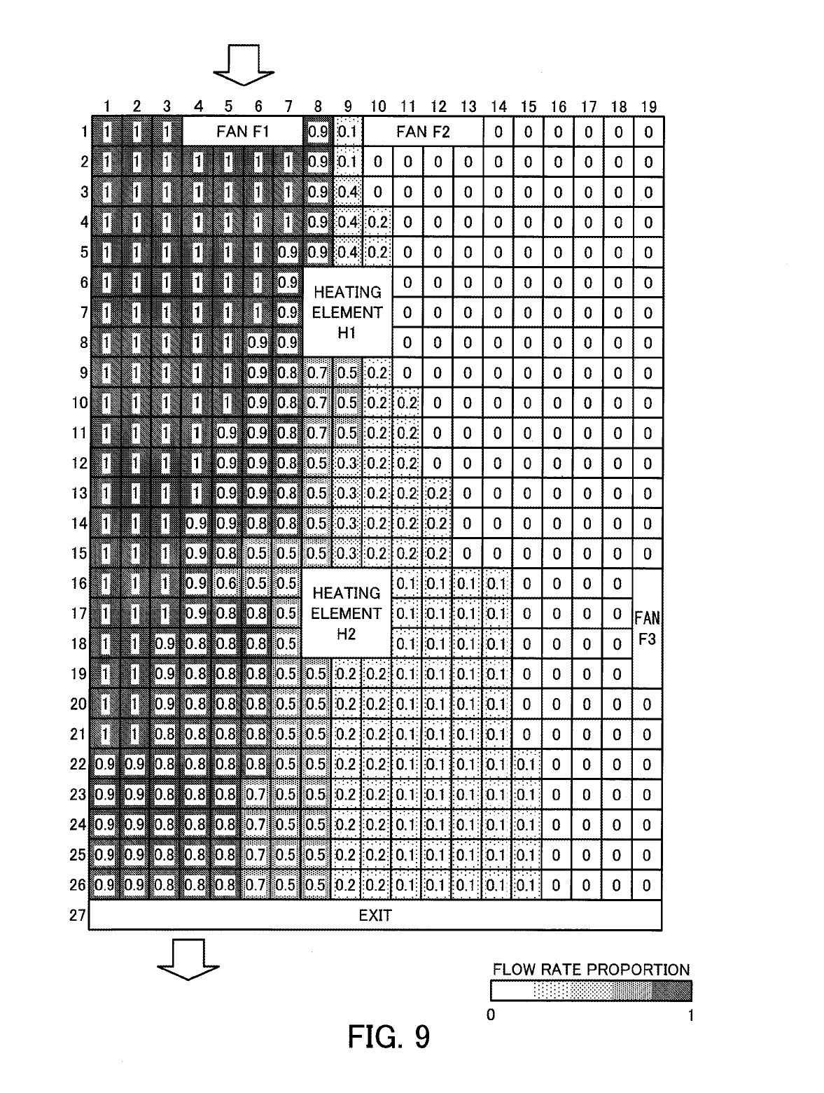

FIG. 9 illustrates a first example of a flow rate distribution. FIG. 9 exemplifies the flow rate distribution of the air delivered by the fan F1, qₙ (n=fan1), at the time of all the fans F1, F2, and F3 being in operation. The numerical value appearing in each cell represents the flow rate proportion qₙ/q (n=fan1). A cell with a darker shading has a higher flow rate while a cell with a lighter shading has a lower flow rate (the same applies to other flow rate distributions below). In the flow rate distribution associated with the fan F1, a relatively high flow rate region is found in a cell range from about 1 to 8 in X.

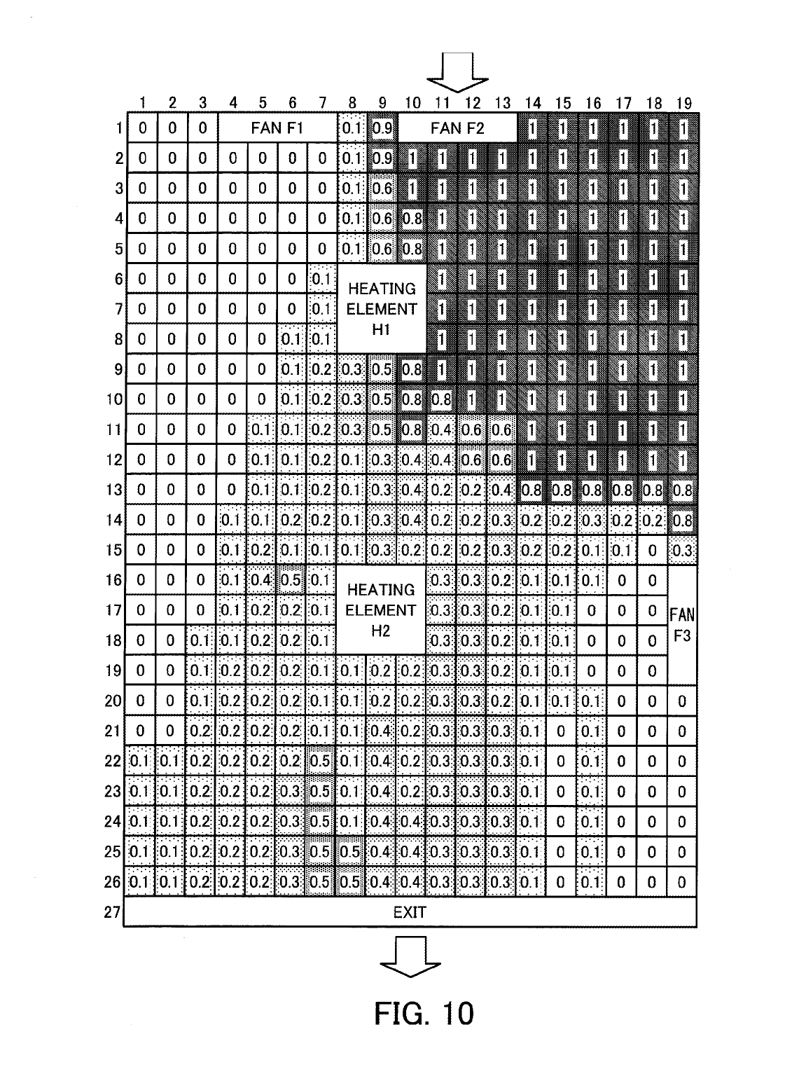

FIG. 10 illustrates a second example of the flow rate distribution. FIG. 10 exemplifies the flow rate distribution of the air delivered by the fan F2, qₙ (n=fan2), at the time of all the fans F1, F2, and F3 being in operation. The numerical value appearing in each cell represents the flow rate proportion qₙ/q (n=fan2). In the flow rate distribution associated with the fan F2, a relatively high flow rate region is found in a cell range from about 9 to 19 in X and from about 1 to 13 in Y.

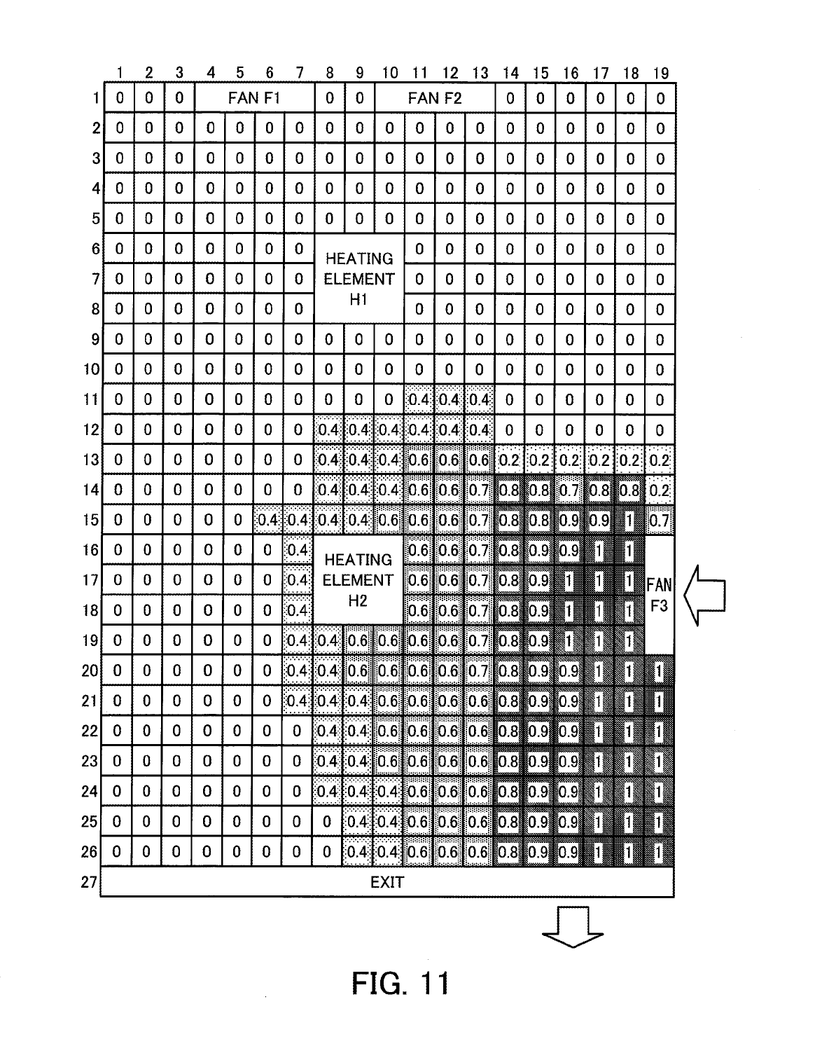

FIG. 11 illustrates a third example of the flow rate distribution. FIG. 11 exemplifies the flow rate distribution of the air delivered by the fan F3, qₙ (n=fan3), at the time of all the fans F1, F2, and F3 being in operation. The numerical value appearing in each cell represents the flow rate proportion qₙ/q (n=fan3). In the flow rate distribution associated with the fan F3, a relatively high flow rate region is found in a cell range from about 11 to 19 in X and from about 14 to 26 in Y.

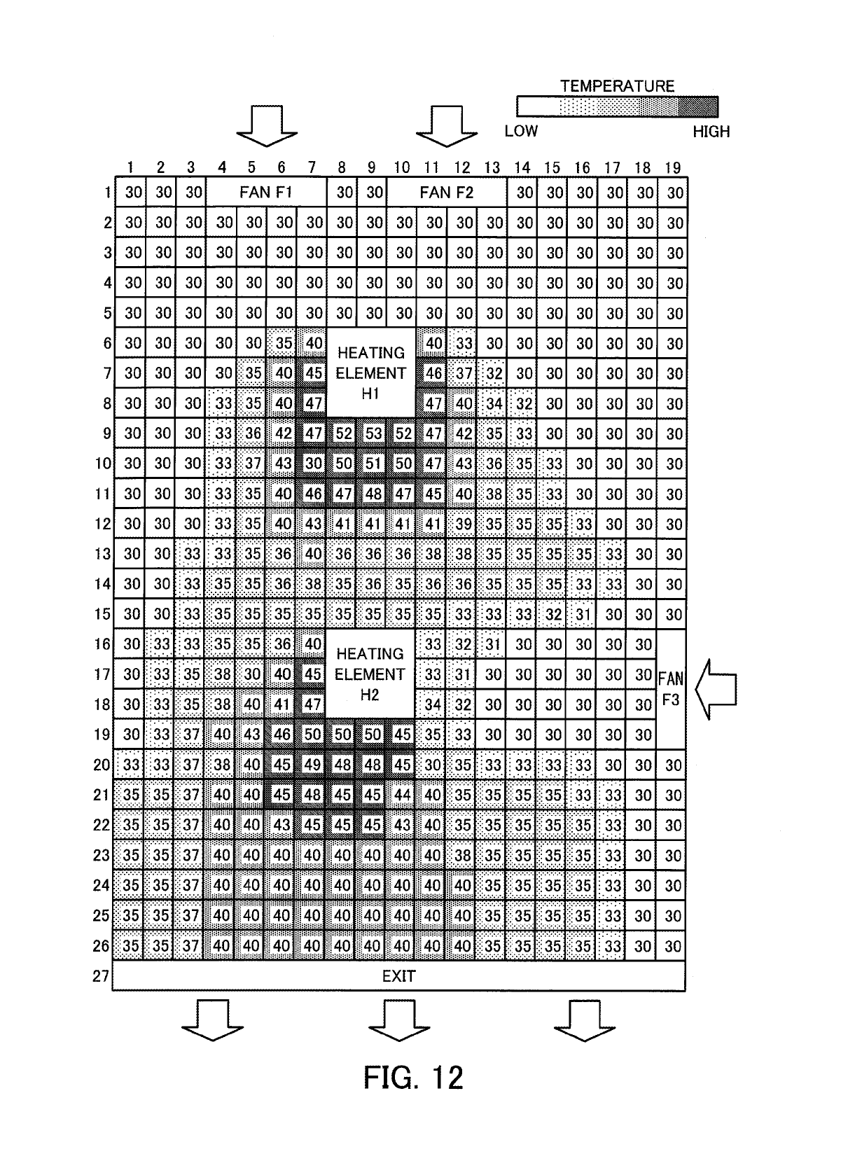

FIG. 12 illustrates an example of a temperature distribution of mixed air. FIG. 12 exemplifies the temperature distribution T in a steady state at the time of all the fans F1, F2, and F3 being in operation. The numerical value appearing in each cell represents the temperature in degree Celsius (T−273.15). A cell with a darker shading has a higher temperature while a cell with a lighter shading has a lower temperature. It is understood from the temperature distribution T, for example, that the temperatures on the windward side of each of the heating elements H1 and H2 are relatively low and the temperatures on the leeward side are relatively high. The cooling performance evaluating unit 120 obtains the individual distributions of FIGS. 8 to 12 in step S12 (the thermal fluid analysis using a conventional CFD method) described in FIG. 7.

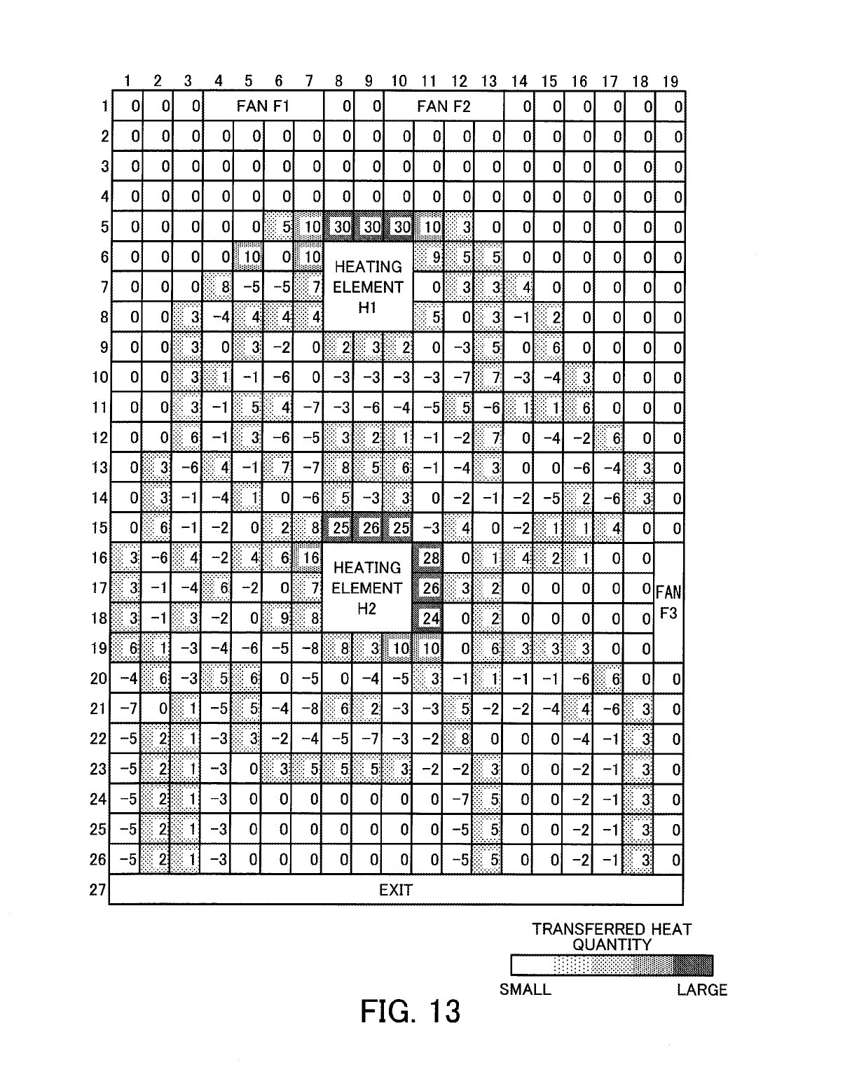

FIG. 13 illustrates an example of a transferred heat quantity distribution. FIG. 13 exemplifies the transferred heat quantity distribution h₀ based on the temperature distribution T. As described in step S13 of FIG. 7, the cooling performance evaluating unit 120 plugs the temperature distribution T into Equation (3) to thereby obtain the transferred heat quantity distribution h₀. For example, it is understood from the transferred heat quantity distribution h₀ that the transferred heat quantities on the windward side of each of the heating elements H1 and H2 are large and the transferred heat quantities on the leeward side are small.

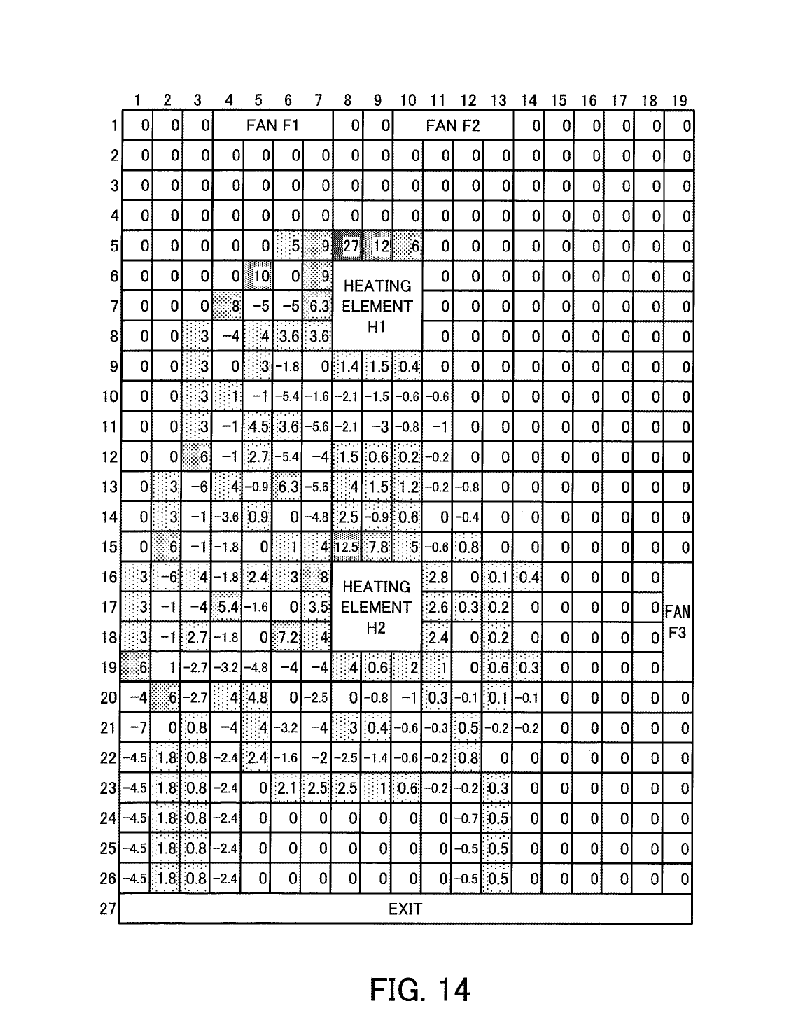

FIG. 14 illustrates a first example of a fan-specific transferred heat quantity distribution (with initial values). FIG. 14 exemplifies initial values of the transferred heat quantity distribution hₙ (n=fan1) associated with the fan F1. The initial values are obtained by multiplying the transferred heat quantity distribution h₀ of FIG. 13 by each flow ratio of the air from the fan F1 (qₙ/q) (n=fan1). For example, hₙ (n=fan1) of each cell equals h₀ of the cell times qₙ/q (n=fan1) of the cell (the same applies hereinafter).

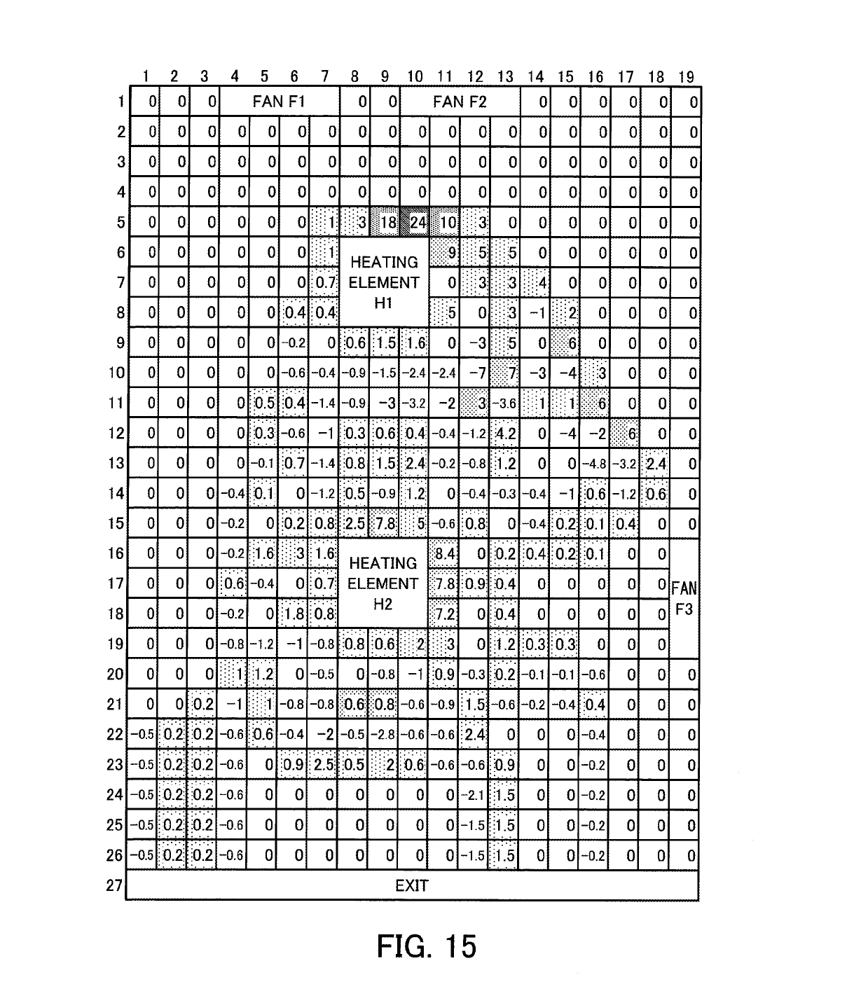

FIG. 15 illustrates a second example of the fan-specific transferred heat quantity distribution (with initial values). FIG. 15 exemplifies initial values of the transferred heat quantity distribution hₙ (n=fan2) associated with the fan F2. The initial values are obtained by multiplying the transferred heat quantity distribution h₀ of FIG. 13 by each flow ratio of the air from the fan F2 (qₙ/q) (n=fan2).

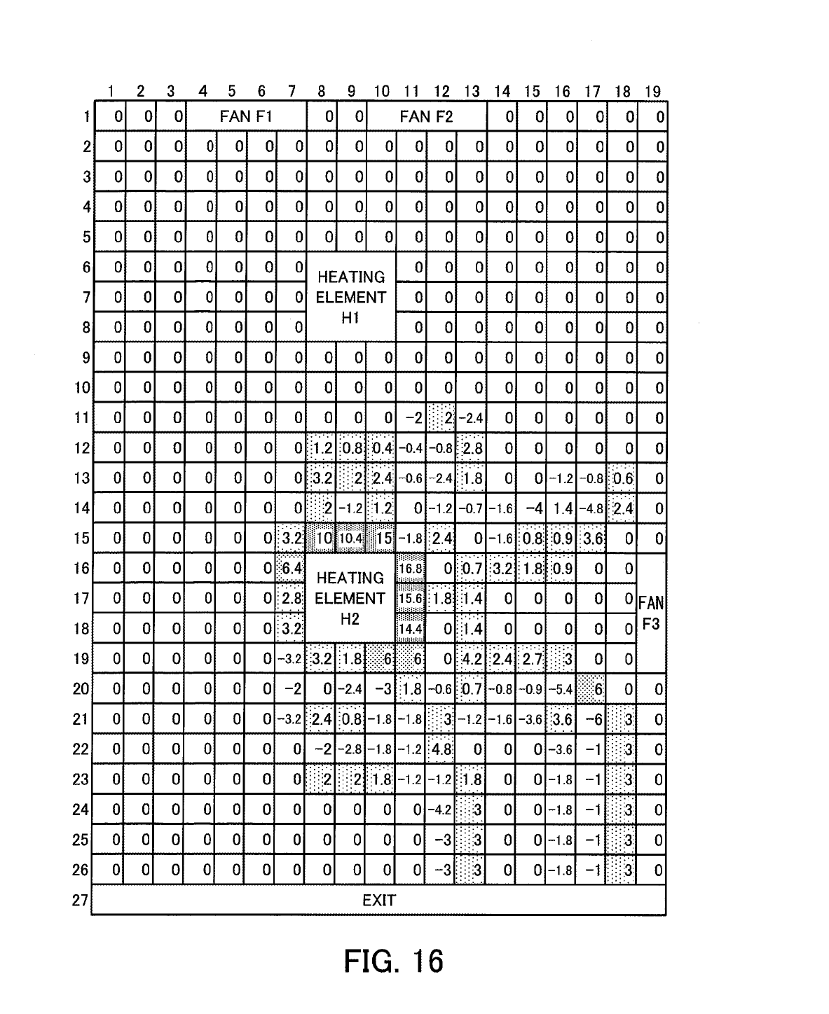

FIG. 16 illustrates a third example of the fan-specific transferred heat quantity distribution (with initial values). FIG. 16 exemplifies initial values of the transferred heat quantity distribution hₙ (n=fan3) associated with the fan F3. The initial values are obtained by multiplying the transferred heat quantity distribution h₀ of FIG. 13 by each flow ratio of the air from the fan F3 (qₙ/q) (n=fan3). The cooling performance evaluating unit 120 obtains the individual distributions hₙ of FIGS. 14 to 16 in step S14 described in FIG. 7.

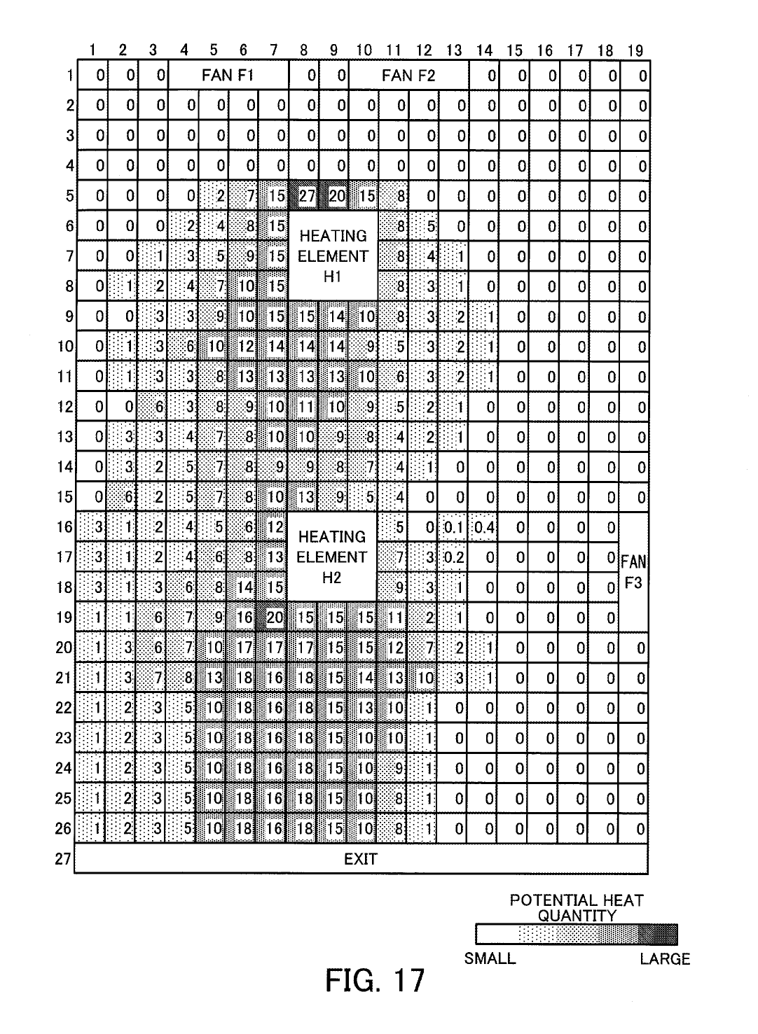

FIG. 17 illustrates a first example of a fan-specific potential heat quantity distribution (with initial values). FIG. 17 exemplifies initial values of the potential heat quantity distribution Wₙ (n=fan1) associated with the fan F1. The initial values of the potential heat quantity distribution Wₙ (n=fan1) are obtained from Equations (7) and (8) using the transferred heat quantity distribution hₙ (n=fan1) of FIG. 14.

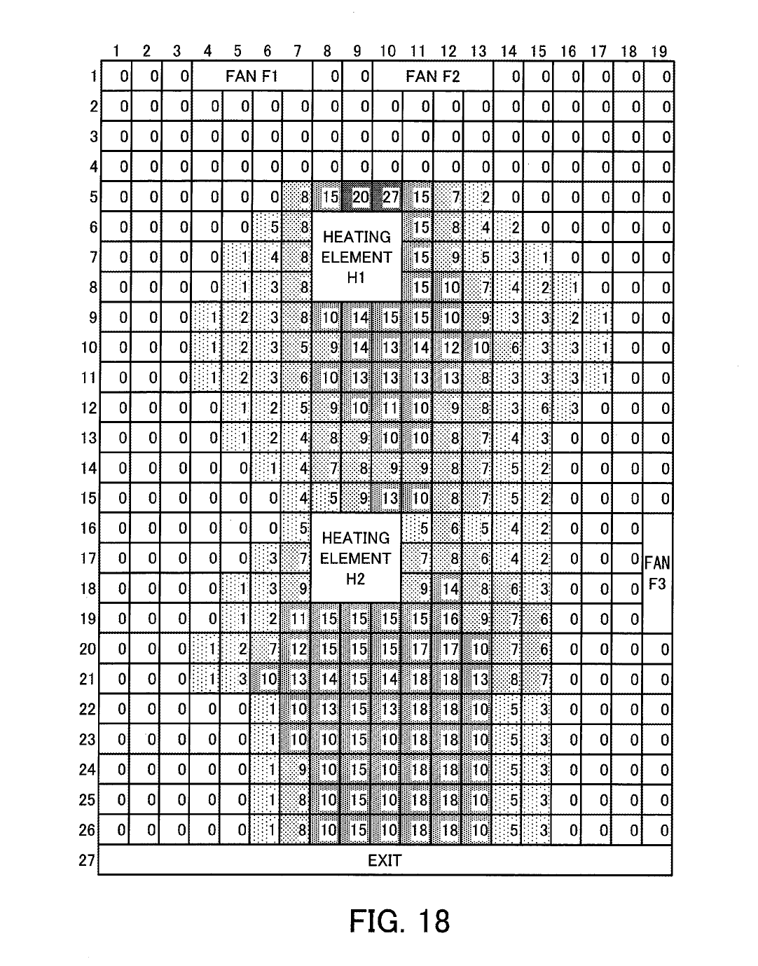

FIG. 18 illustrates a second example of the fan-specific potential heat quantity distribution (with initial values). FIG. 18 exemplifies initial values of the potential heat quantity distribution Wₙ (n=fan2) associated with the fan F2. The initial values of the potential heat quantity distribution Wₙ (n=fan2) are obtained from Equations (7) and (8) using the transferred heat quantity distribution hₙ (n=fan2) of FIG. 15.

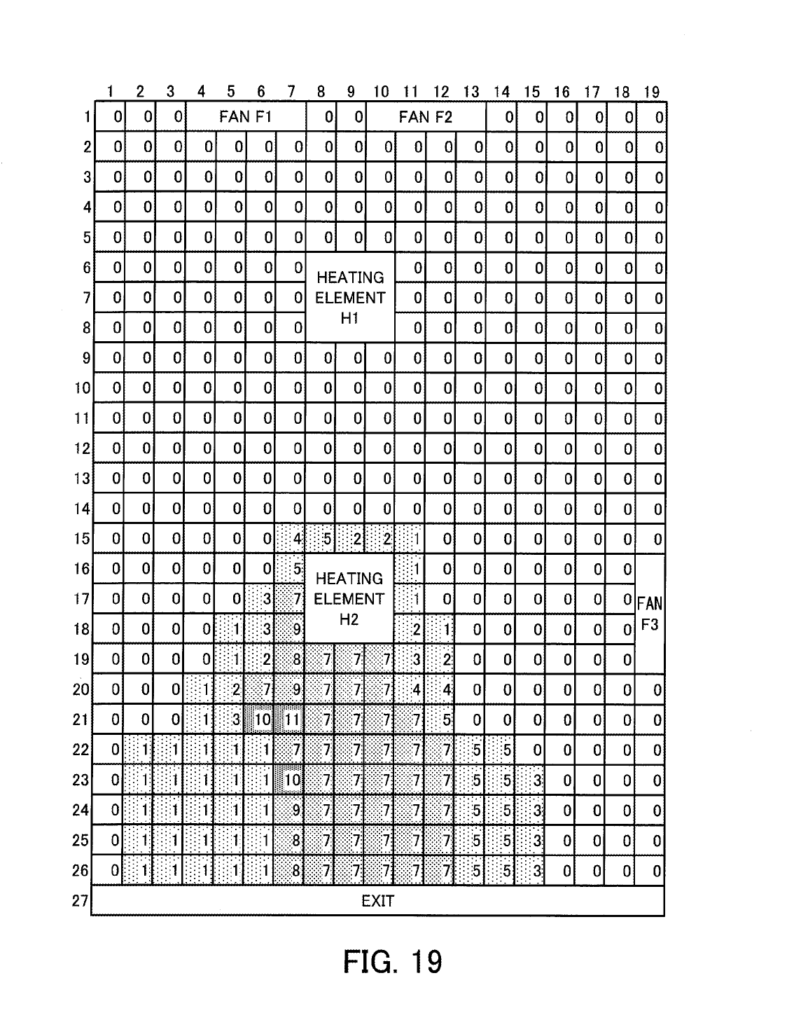

FIG. 19 illustrates a third example of the fan-specific potential heat quantity distribution (with initial values). FIG. 19 exemplifies initial values of the potential heat quantity distribution Wₙ (n=fan3) associated with the fan F3. The initial values of the potential heat quantity distribution Wₙ (n=fan3) are obtained from Equations (7) and (8) using the transferred heat quantity distribution hₙ (n=fan3) of FIG. 16. The cooling performance evaluating unit 120 obtains the individual distributions Wₙ of FIGS. 17 to 19 in step S15 described in FIG. 7.

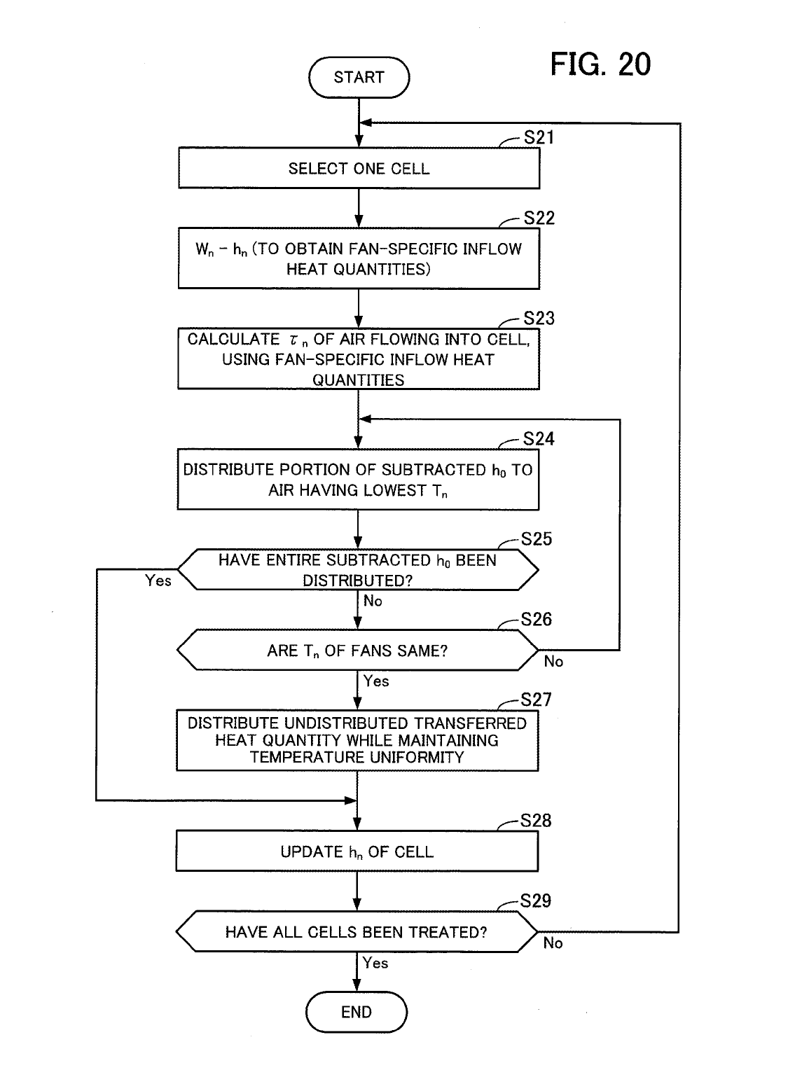

Next described are procedures for updating the individual fan-specific transferred heat quantity distributions in step S16 of FIG. 7. FIG. 20 is a flowchart illustrating an example of a process for updating fan-specific transferred heat quantity distributions. The process of FIG. 20 is described next according to the step numbers in the flowchart.

(Step S21) The cooling performance evaluating unit 120 selects one cell from untreated cells.

(Step S22) With respect to each of the fans F1, F2, and F3, the cooling performance evaluating unit 120 calculates a fan-specific inflow heat quantity (Wₙ−hₙ) by subtracting the fan-specific transferred heat quantity hₙ from the fan-specific potential heat quantity Wₙ (that is, W_{fan1}−h_{fan1}, for example). Note that the values of Wₙ and hₙ are those of the cell selected in step S21 (the same applies hereinafter).

(Step S23) With respect to each of the fans F1, F2, and F3, the cooling performance evaluating unit 120 calculates a fan-specific temperature τₙ(x) of air flowing into the cell by the fan, using Equation (9).

$${τ}_{n}^{( i )} ( {x}^{->} ) = \frac{{W}_{n}^{( i )} ( {x}^{->} ) - {h}_{n}^{( i )} ( {x}^{->} )}{C \cdot ρ \cdot {q}_{n} ( {x}^{->} )} \qquad ( 9 )$$

where C is the specific heat of air (J/(g·K)), ρ is the air density, and qₙ is the flow rate.

(Step S24) As for the air delivered by the individual fans, the cooling performance evaluating unit 120 identifies air whose temperature Tₙ is the lowest, and distributes a portion of Σhₙ=h₀ (the symbol Σ means to sum n) subtracted in step S22 to the air having the lowest temperature Tₙ. Note that the value of h₀ is that of the cell selected in step S21. The amount to be distributed at a time is optionally determined. For example, the amount of distribution, such as h₀/100 and h₀/50, is indicated in advance to the cooling performance evaluating unit 120. The sum total of the distributed amounts for each fan corresponds to hₙ obtained at the i+1-th iteration. In this manner, the i+1-th hₙ is obtained based on hₙ obtained at the i-th iteration. Note that the relationship of Tₙ and τₙ is given by Equation (10) below.

$${T}_{n}^{( i + 1 )} ( {x}^{->} ) = {τ}_{n}^{( i )} ( {x}^{->} ) + \frac{{h}_{n}^{( i + 1 )} ( {x}^{->} )}{C \cdot ρ \cdot {q}_{n} ( {x}^{->} )} \qquad ( 10 )$$

(Step S25) The cooling performance evaluating unit 120 determines whether the entire heat quantity corresponding to the transferred heat quantity h₀ subtracted in step S22 has been distributed to the air delivered by the individual fans. If the entire heat quantity has been distributed, the cooling performance evaluating unit 120 advances the process to step S28. If not, the cooling performance evaluating unit 120 advances the process to step S26. For example, the cooling performance evaluating unit 120 determines that the entire heat quantity has been distributed if the sum total of the distributed quantities equals to h₀ after repeatedly executing step S24. On the other hand, if the sum total of the distributed quantities is smaller than h₀, the cooling performance evaluating unit 120 determines that the entire heat quantity has yet to be distributed.

(Step S26) The cooling performance evaluating unit 120 determines whether the temperatures Tₙ of the air delivered by the individual fans have reached the same temperature. If the temperatures Tₙ are the same, the cooling performance evaluating unit 120 advances the process to step S27. If not, the cooling performance evaluating unit 120 advances the process to step S24.

(Step S27) The cooling performance evaluating unit 120 distributes undistributed transferred heat quantity to the air delivered by the individual fans while maintaining the uniformity of the temperatures of the air delivered by the fans. The processing of steps S24 to S27 would be said to be an operation for obtaining the i+1-th hₙ under the conditions defined by Equation (10) above and Equations (11), (12), and (13) below.

$$\begin{matrix}{\sum }_{n} {h}_{n}^{( i + 1 )} = {\sum }_{n} {h}_{n}^{( i )} & ( 11 ) \\ = {h}_{0} & ( 12 ) \\ {T}_{fan 1}^{( i + 1 )} \approx {T}_{fan 2}^{( i + 1 )} \approx {T}_{fan 3}^{( i + 1 )} & ( 13 )\end{matrix}$$

(Step S28) The cooling performance evaluating unit 120 updates the fan-specific transferred heat quantities of the cell selected in step S21 with the i+1-th hₙ eventually obtained by the processing of steps S24 to S27.

(Step S29) The cooling performance evaluating unit 120 determines whether all the cells in the internal space of the chassis 200 have been treated. If all the cells have been treated, the cooling performance evaluating unit 120 ends the process. If not all of the cells have been treated and thus untreated cells remain, the cooling performance evaluating unit 120 advances the process to step S21.

In the above-described manner, the cooling performance evaluating unit 120 updates the fan-specific transferred heat quantity distributions hₙ.

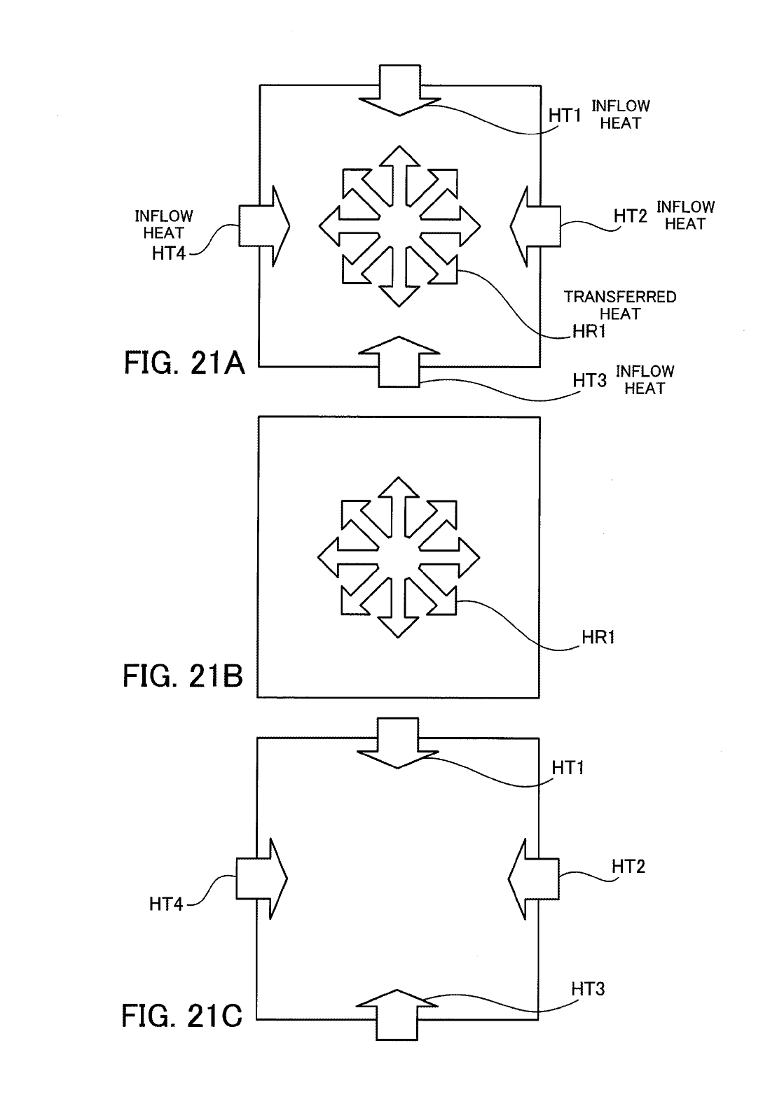

FIGS. 21A, 21B, and 21C illustrate transferred heat and inflow heat of a cell. FIG. 21A illustrates types of heat stored in one cell. FIG. 21B illustrates transferred heat HR1. FIG. 21C illustrates inflow heat HT1, HT2, HT3, and HT4.

When the focus is set to one cell, heat stored in the cell due to air delivered by the individual fans is considered as a sum of heat removed by the air in the cell (the transferred heat HR1) and heat flowing into the cell from adjacent cells (the inflow heat HT1, HT2, HT3, and HT4). Therefore, the transferred heat quantities hₙ corresponding to the transferred heat HR1 is subtracted from the potential heat quantities Wₙ to thereby obtain an inflow heat quantity corresponding to the total amount of the inflow heat HT1, HT2, HT3, and HT4. Then, based on the inflow heat quantity, the temperature of the air flowing into the cell is estimated. As for the air delivered by the individual fans, the transferred heat quantities hₙ are adjusted in such a manner that the temperatures of the air delivered by the individual fans reach the same temperature. This adjustment is made based on the consideration that, even if the temperatures of the air delivered to the cell by the individual fans are different from each other, the air from the individual fans blends together inside the cell and therefore has reached the same temperature when flowing out of the cell.

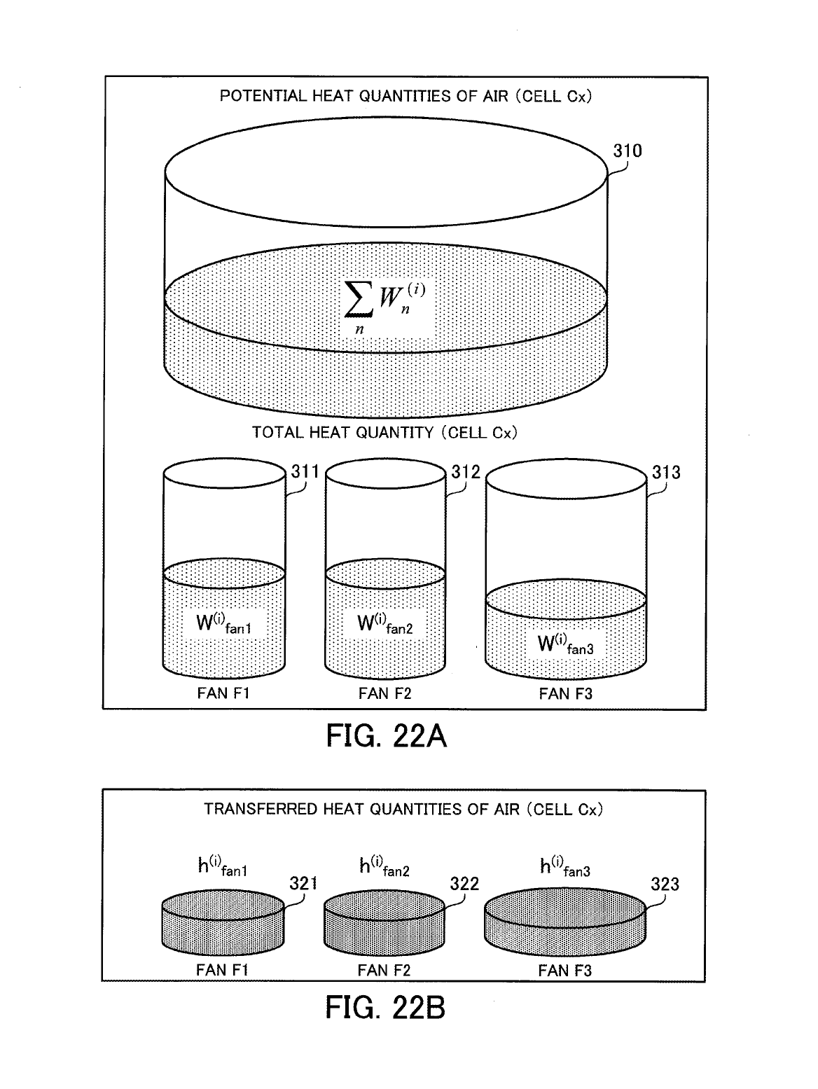

FIGS. 22A and 22B illustrate an example of potential heat quantities and transferred heat quantities of a cell. FIG. 22A illustrates potential heat quantities Wₙ (i-th iteration) of air in a cell Cx. For example, the potential heat quantities of the air delivered by the individual fans are represented by cylinders 311, 312, and 313. The cross-sectional area of each cylinder corresponds to Cρ (qₙ) (the product of the specific heat, density, and flow rate). The cylinder 311 represents the potential heat quantity Wₙ (n=fan1) of the fan F1. The cylinder 312 represents the potential heat quantity Wₙ (n=fan2) of the fan F2. The cylinder 313 represents the potential heat quantity Wₙ (n=fan3) of the fan F3. ΣWₙ (the symbol Σ means to sum n) is a total potential heat quantity of the cell Cx.

FIG. 22B exemplifies transferred heat quantities hₙ (i-th iteration) of the air in the cell Cx. The transferred heat quantities of the air delivered by the individual fans are represented by cylinders 321, 322, and 323. The cross-sectional area of each cylinder corresponds to Cρ (qₙ), as in FIG. 22A. The cylinder 321 represents the transferred heat quantity hₙ (n=fan1) of the fan F1. The cylinder 322 represents the transferred heat quantity hₙ (n=fan2) of the fan F2. The cylinder 323 represents the transferred heat quantity hₙ (n=fan3) of the fan F3.

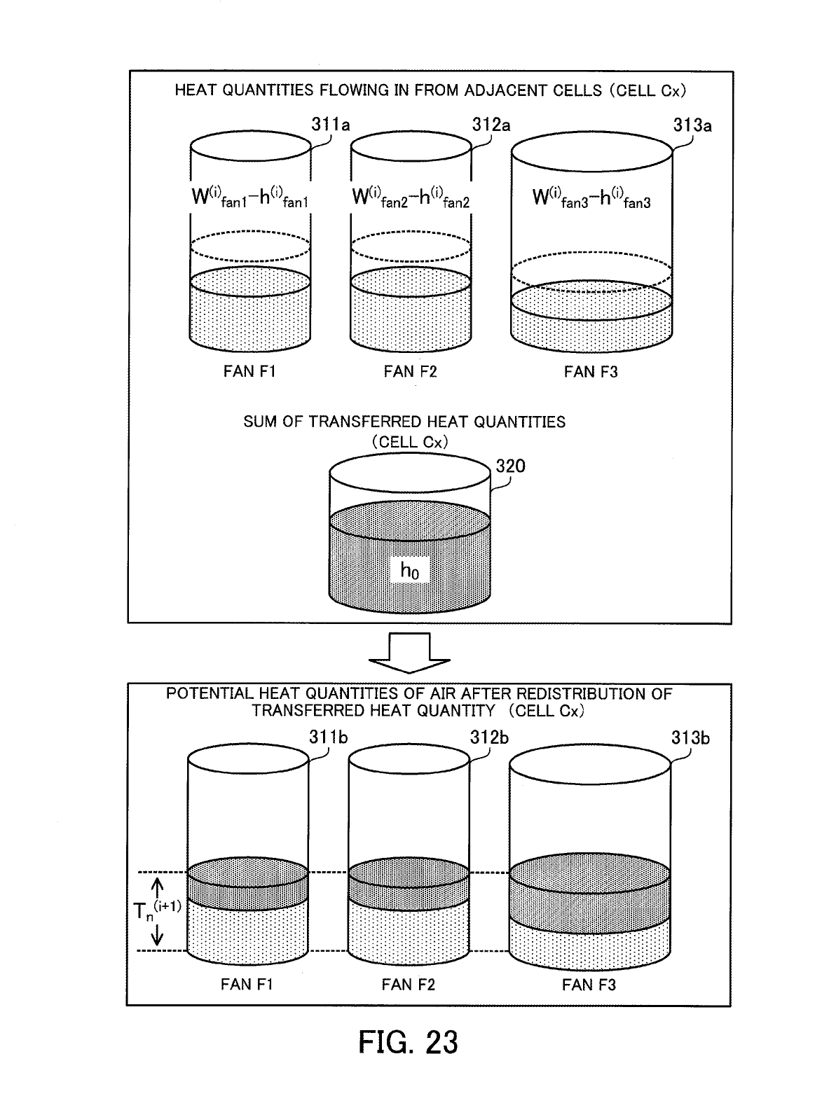

FIG. 23 illustrates an example of inflow heat quantities and updated potential heat quantities of a cell. The inflow heat quantities (i-th iteration) corresponding to the potential heat quantities Wₙ and the transferred heat quantities hₙ of FIG. 22A are represented by cylinders 311a, 312a, and 313a. The cylinder 311a represents the inflow heat quantity (Wₙ−hₙ) (n=fan1) associated with the fan F1. The cylinder 312a represents the inflow heat quantity (Wₙ−hₙ) (n=fan2) associated with the fan F2. The cylinder 313a represents the inflow heat quantity (Wₙ-hₙ) (n=fan3) associated with the fan F3. Note that a cylinder 320 represents the sum of the transferred heat quantities hₙ, Σhₙ=h₀ (the symbol Σ means to sum n).

Then, the summed transferred heat quantity h₀ of the cylinder 320 is redistributed to each of the cylinders 311a, 312a, and 313a. At this point, the redistribution is made in such a manner that the temperatures Tₙ of the air delivered by the individual fans (corresponding to the height of the individual cylinders) become substantially the same. Cylinders 311b, 312b, and 313b represent potential heat quantities of the air delivered by the individual fans after the summed transferred heat quantity h₀ of the cylinder 320 is redistributed in this manner. The cylinder 311b is obtained after the redistribution of the summed transferred heat quantity h₀ to the cylinder 311a. The cylinder 312b is obtained after the redistribution of the summed transferred heat quantity h₀ to the cylinder 312a. The cylinder 313b is obtained after the redistribution of the summed transferred heat quantity h₀ to the cylinder 313a.

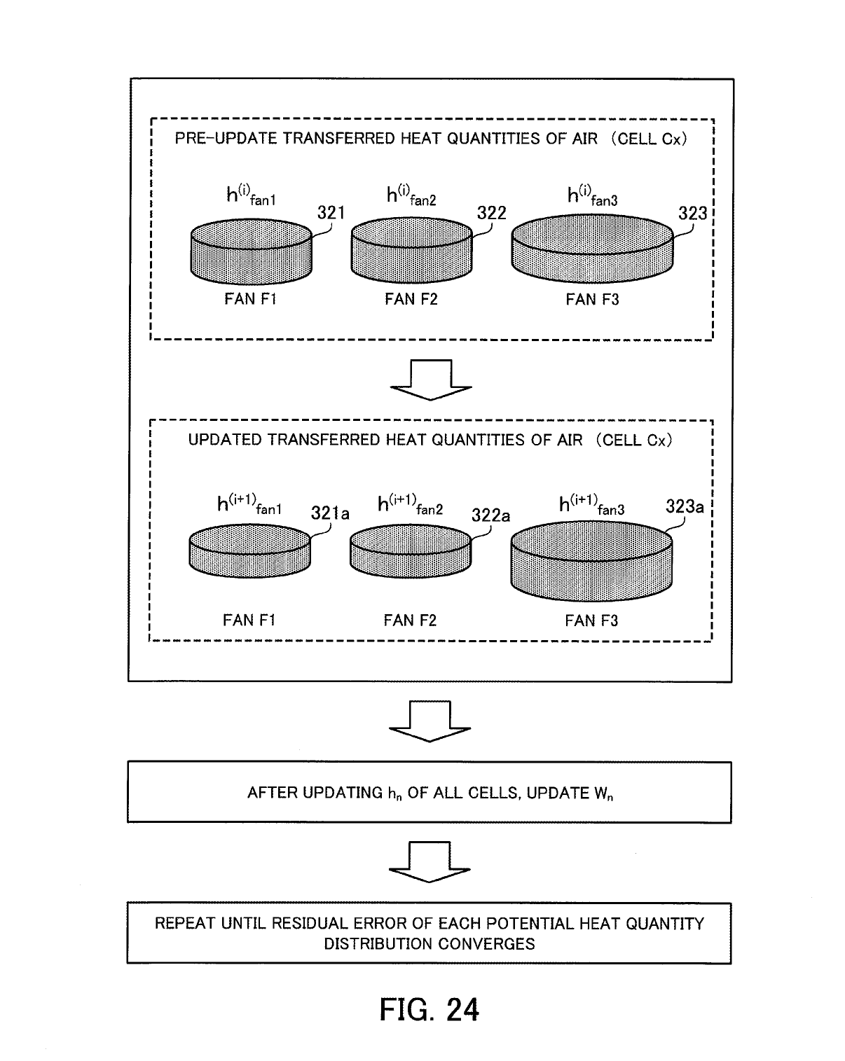

FIG. 24 illustrates an example of an update of transferred heat quantities of a cell. Cylinders 321a, 322a, and 323a are obtained by updating the cylinders 321, 322, and 323, respectively (after i+1 iterations). That is, the cylinder 321a represents an updated transferred heat quantity hₙ (n=fan1) of the air delivered to the cell Cx by the fan F1. The cylinder 322a represents an updated transferred heat quantity hₙ (n=fan2) of the air delivered to the cell Cx by the fan F2. The cylinder 323a represents an updated transferred heat quantity hₙ (n=fan3) of the air delivered to the cell Cx by the fan F3.

With respect to all the cells, the cooling performance evaluating unit 120 carries out the same process as for the cell Cx to thereby update the fan-specific transferred heat quantity distributions hₙ. Subsequently, the cooling performance evaluating unit 120 repeatedly updates the transferred heat quantity distributions hₙ using Equations (7), (8), (9), (10), (11), (12), and (13).

The cooling performance evaluating unit 120 iteratively adjusts the transferred heat quantity distributions hₙ, for example, until the residual error of each of the potential heat quantity distributions Wₙ based on the individual cell values converges to ε (ε is a positive real number) as defined by Equation (14). The cooling performance evaluating unit 120 is provided with the value ε in advance.

|Wₙ⁽ⁱ⁺¹⁾−Wₙ⁽ⁱ⁾|≦ε (14)

In the above-described manner, final transferred heat quantities hₙ are determined. Note that the cooling performance evaluating unit 120 may end the adjustment of the transferred heat quantities hₙ when the residual error of the energy density distributions ψₙ or the temperature distributions Tₙ has converged.

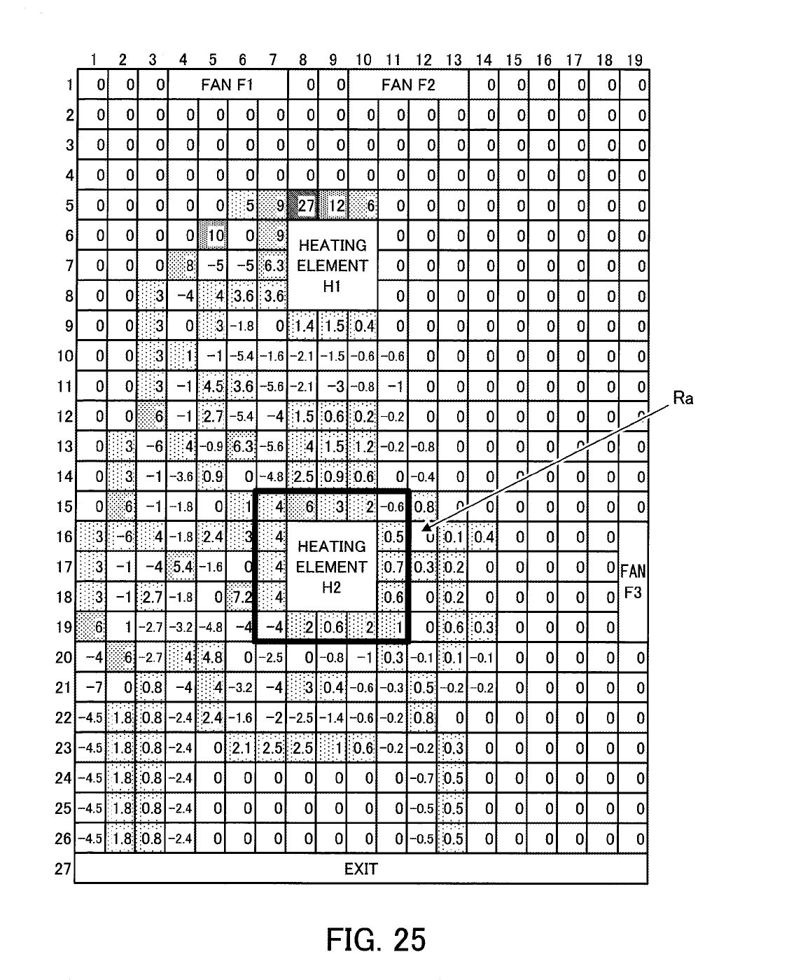

FIG. 25 illustrates a first example of a fan-specific transferred heat quantity distribution (after convergence). FIG. 25 exemplifies the finally obtained transferred heat quantity distribution hₙ (n=fan1) associated with the fan F1. Compared with FIG. 14, the transferred heat quantities of cells included in a cell range Ra are significantly more adjusted than those of cells in elsewhere. The cell range Ra extends from 7 to 11 in X and from 15 to 19 in Y, and coincides with the surrounding region of the heating element H2, in which the air delivered by the fans F1 and F2 is considered to be affected to a greater degree by a blast of the air delivered by the fan F3 compared to elsewhere.

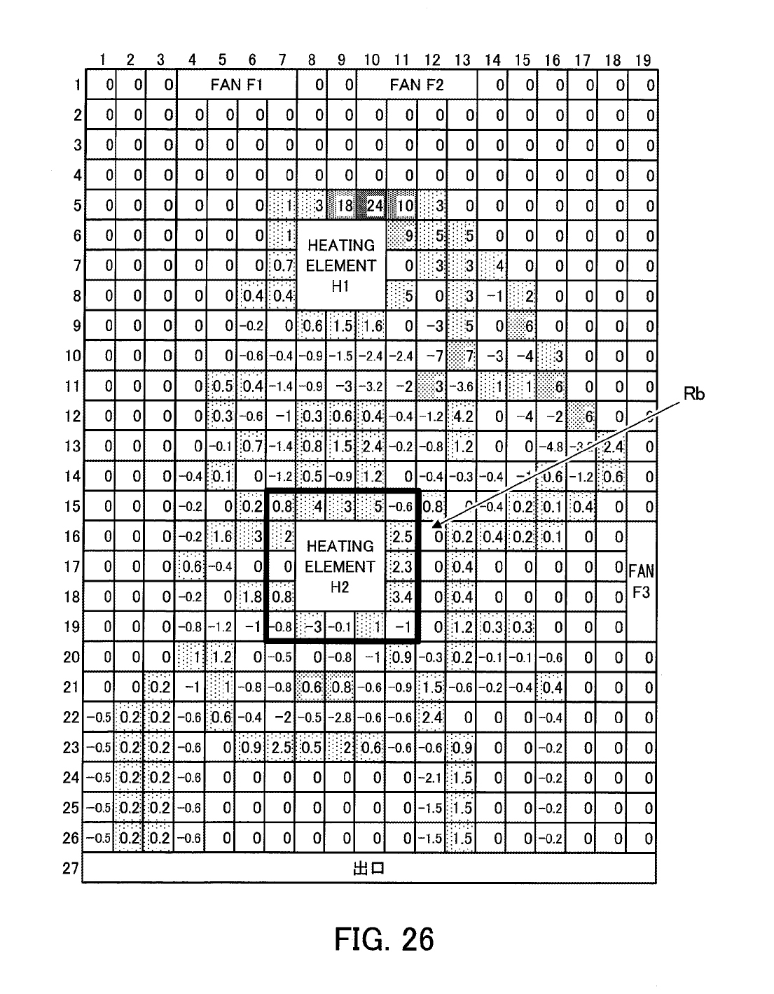

FIG. 26 illustrates a second example of the fan-specific transferred heat quantity distribution (after convergence). FIG. 26 exemplifies the finally obtained transferred heat quantity distribution hₙ (n=fan2) associated with the fan F2. Compared with FIG. 15, the transferred heat quantities of cells included in a cell range Rb are significantly more adjusted than those of cells in elsewhere, as in FIG. 25. Note here that the cell range Rb occupies the same X-Y coordinate range as the cell range Ra.

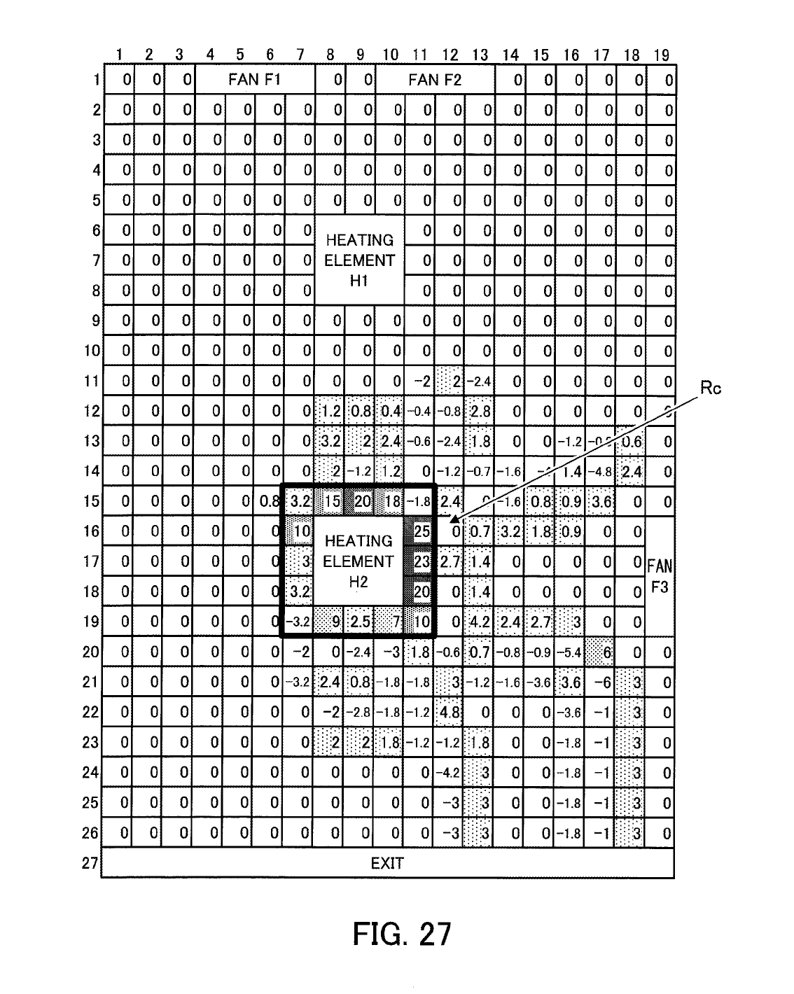

FIG. 27 illustrates a third example of the fan-specific transferred heat quantity distribution (after convergence). FIG. 27 exemplifies the finally obtained transferred heat quantity distribution hₙ (n=fan3) associated with the fan F3. Compared with FIG. 16, the transferred heat quantities of cells included in a cell range Rc are significantly more adjusted than those of cells in elsewhere, as in FIG. 25. Note here that the cell range Rc occupies the same X-Y coordinate range as the cell range Ra.

Thus, according to the procedure of FIG. 20, in the transferred heat quantity distributions hₙ, much larger adjustment is made in the cell ranges Ra, Rb, Rc, which are subject to a relatively substantial influence by the blast of air, than elsewhere. That is, even when there is an influence by the blast of air, the influence is appropriately reflected in the transferred heat quantity distributions hₙ.

The cooling performance evaluating unit 120 accepts, from a user, a selection of one of the transferred heat quantity distributions hₙ (n=fan1, fan2, and fan3) of FIGS. 25 to 27, and then causes the display 11 to display an image (like one illustrated in FIG. 25, 26, or 27) representing the selected transferred heat quantity distribution hₙ. In addition, the cooling performance evaluating unit 120 also accepts, from the user, a selection of one of the potential heat quantity distributions Wₙ (n=fan1, fan2, and fan3) corresponding to the transferred heat quantity distributions hₙ. The cooling performance evaluating unit 120 causes the display 11 to display an image representing the selected potential heat quantity distribution W.

For example, the cooling performance evaluating unit 120 displays each of the distributions selected by the user on the display 11 in such a manner that representations (for example, numerical values, colors, or color shading) according to the values of the individual cells in the selected distribution appear, in an image of the internal space of the chassis 200, at corresponding locations of the cells. By reviewing the images of the transferred heat quantity distributions hₙ and the potential heat quantity distributions Wₙ, the user is able to readily understand the cooling effect of each of the fans to cool each heating element.

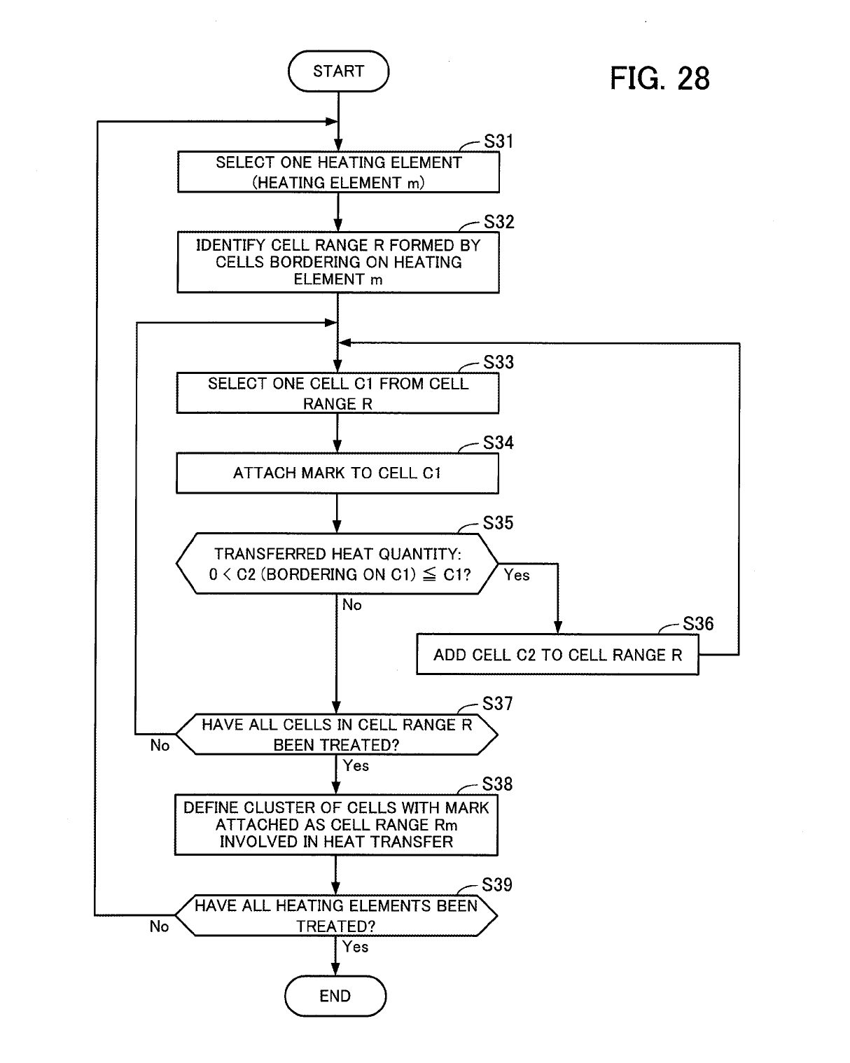

Next described are procedures for identifying cell ranges involved in heat transfer in step S19 of FIG. 7. FIG. 28 is a flowchart illustrating an example of a process for identifying cell ranges involved in heat transfer. The process of FIG. 28 is described next according to the step numbers in the flowchart.

(Step S31) The cooling performance evaluating unit 120 selects one of heating elements included in the analysis object model. The selected heating element is referred to as the heating element m.

(Step S32) The cooling performance evaluating unit 120 obtains a cell range R formed by cells bordering on the heating element m. For example, in the case of heating element H1, the cell range R is formed by cells at X-Y coordinates of (8, 5), (9, 5), (10, 5), (7, 6), (11, 6), (7, 7), (11, 7), (7, 8), (11, 8), (8, 9), (9, 9), and (10, 9).

(Step S33) The cooling performance evaluating unit 120 selects one cell C1 from the cell range R.

(Step S34) The cooling performance evaluating unit 120 attaches a mark to the cell C1. For example, the cell C1 is provided with a mark indicating that the cell is included in a cell range Rₘ involved in heat transfer of the heating element m (for example, a flag with ‘true’ in association with the coordinates of the cell C1).

(Step S35) The cooling performance evaluating unit 120 obtains an adjoining cell C2 bordering on the cell C1. If there is more than one adjoining cell, a plurality of adjoining cells C2 are obtained. The cooling performance evaluating unit 120 determines whether the transferred heat quantity of the adjoining cell C2 satisfies the following relationship: 0<transferred heat quantity of adjoining cell C2≦transferred heat quantity of cell C1. If the relationship is satisfied, the cooling performance evaluating unit 120 advances the process to step S36. If not, the cooling performance evaluating unit 120 advances the process to step S37. Note that, when a plurality of adjoining cells C2 have been obtained, the cooling performance evaluating unit 120 advances the process to step S36 if at least one of the adjoining cells C2 satisfies the relationship.

(Step S36) The cooling performance evaluating unit 120 adds the cell C2 to the cell range R. In the case where a plurality of cells C2 satisfy the relationship in step S35, these cells C2 are added to the cell range R. Note however that a cell already included in the cell range R needs not be added redundantly. Subsequently, the cooling performance evaluating unit 120 advances the process to step S33.

(Step S37) The cooling performance evaluating unit 120 determines whether all the cells in the cell range R have been treated. If all the cells in the cell range R have been treated, the cooling performance evaluating unit 120 advances the process to step S38. If not, the cooling performance evaluating unit 120 advances the process to step S33.

(Step S38) The cooling performance evaluating unit 120 defines a cluster of cells each having the mark attached thereto as the cell range Rm involved in heat transfer of the heating element m.

(Step S39) The cooling performance evaluating unit 120 determines whether all heating elements included in the analysis object model have been treated (that is, whether the cell range Rm has been acquired for each of the heating elements). If all the heating elements have been treated, the cooling performance evaluating unit 120 ends the process. If not, the cooling performance evaluating unit 120 advances the process to step S31.

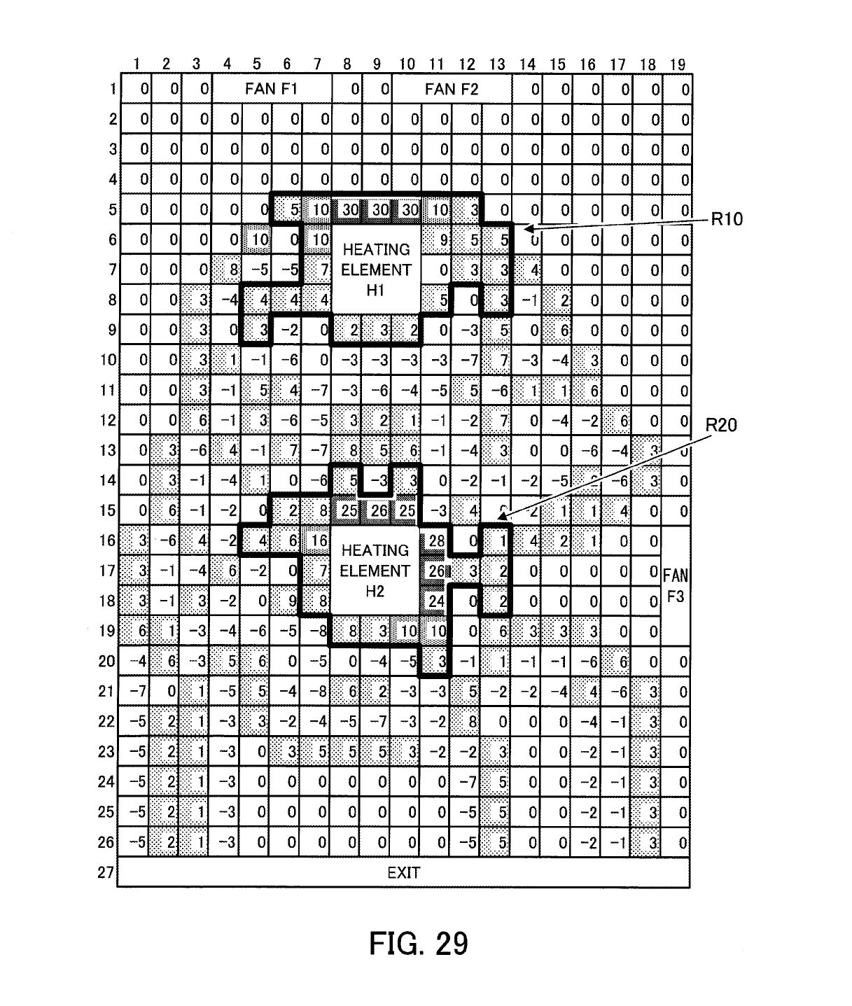

FIG. 29 illustrates an example of cell ranges involved in heat transfer. For example, the cooling performance evaluating unit 120 acquires a cell range R10 for the heating element H1 according to the procedure of FIG. 28. In addition, the cooling performance evaluating unit 120 acquires a cell range R20 for the heating element H2 according to the procedure of FIG. 28.

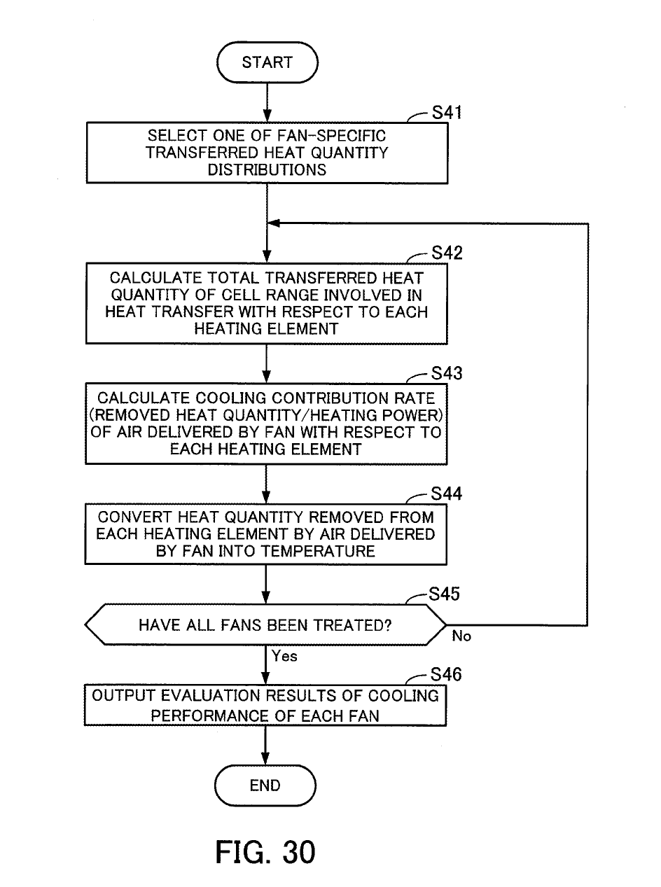

Next described are procedures for evaluating the fan-specific cooling performance in step S20 of FIG. 7. FIG. 30 is a flowchart illustrating an example of a process for evaluating fan-specific cooling performance. The process of FIG. 30 is described next according to the step numbers in the flowchart.

(Step S41) The cooling performance evaluating unit 120 selects one of the fan-specific transferred heat quantity distributions hₙ.

(Step S42) Using Equation (15), the cooling performance evaluating unit 120 calculates a total transferred heat quantity Z_{m,n} of the cell range involved in heat transfer with respect to each heating element m.

$${Z}_{m , n} = {\sum }_{\vec{x} ∈ {R}_{m}} {h}_{n} ( \vec{x} ) \qquad ( 15 )$$

where Z_{m,n} corresponds to the heat quantity removed (per unit time) from the heating power of the heating element m by the air delivered by the fan n.

(Step S43) The cooling performance evaluating unit 120 calculates a cooling contribution rate of the air delivered by the fan, whose fan-specific transferred heat quantity distributions hₙ is selected in step S41, with respect to each heating element m. For example, the cooling contribution rate is obtained by: cooling contribution rate=Z_{m,n}/(heating power of heating element m).

(Step S44) With respect to each heating element m, the cooling performance evaluating unit 120 converts the heat quantity removed from the heating element m by the air delivered by the fan, whose fan-specific transferred heat quantity distributions hₙ is selected in step S41, into a temperature. For example, the temperature is obtained by: temperature=Z_{m,n}/(mass of heating element m×specific heat of heating element m).

(Step S45) The cooling performance evaluating unit 120 determines whether all the fans have been subjected to steps S41 to S44 above. When all the fans have been treated, the cooling performance evaluating unit 120 advances the process to step S46. If not, the cooling performance evaluating unit 120 advances the process to step S41.

(Step S46) The cooling performance evaluating unit 120 outputs evaluation results of the cooling performance of each fan to the display 11, to thereby cause the display 11 to display an image representing the evaluation results.

In the above described manner, the cooling performance evaluating unit 120 evaluates each fan in terms of its degree of contribution to cooling of each of the heating elements, using heat quantities, cooling contribution rates, and temperatures as indexes.

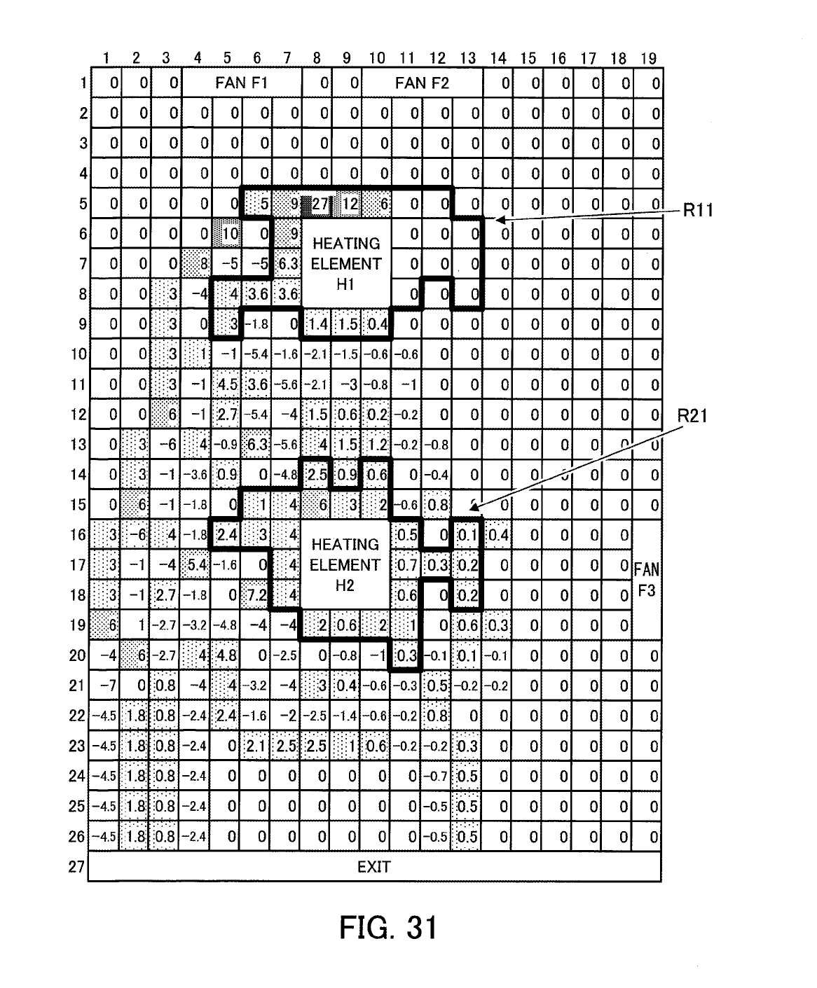

FIG. 31 illustrates a first example of an evaluation of fan-specific cooling performance. FIG. 31 exemplifies a method for evaluating the cooling performance based on the finally obtained transferred heat quantity distribution hₙ (n=fan1) associated with the fan F1. A cell range R11 corresponds to the cell range R10 and includes the same cells as the cell range R10. The cooling performance evaluating unit 120 obtains, based on the transferred heat quantity distribution hₙ (n=fan1), a sum of transferred heat quantities of all the cells included in the cell range R11, to thereby calculate the heat quantity removed from the heating element H1 by the air delivered by the fan F1.

A cell range R21 corresponds to the cell range R20 and includes the same cells as the cell range R20. The cooling performance evaluating unit 120 obtains, based on the transferred heat quantity distribution hₙ (n=fan1), a sum of transferred heat quantities of all the cells included in the cell range R21, to thereby calculate the heat quantity removed from the heating element H2 by the air delivered by the fan F1.

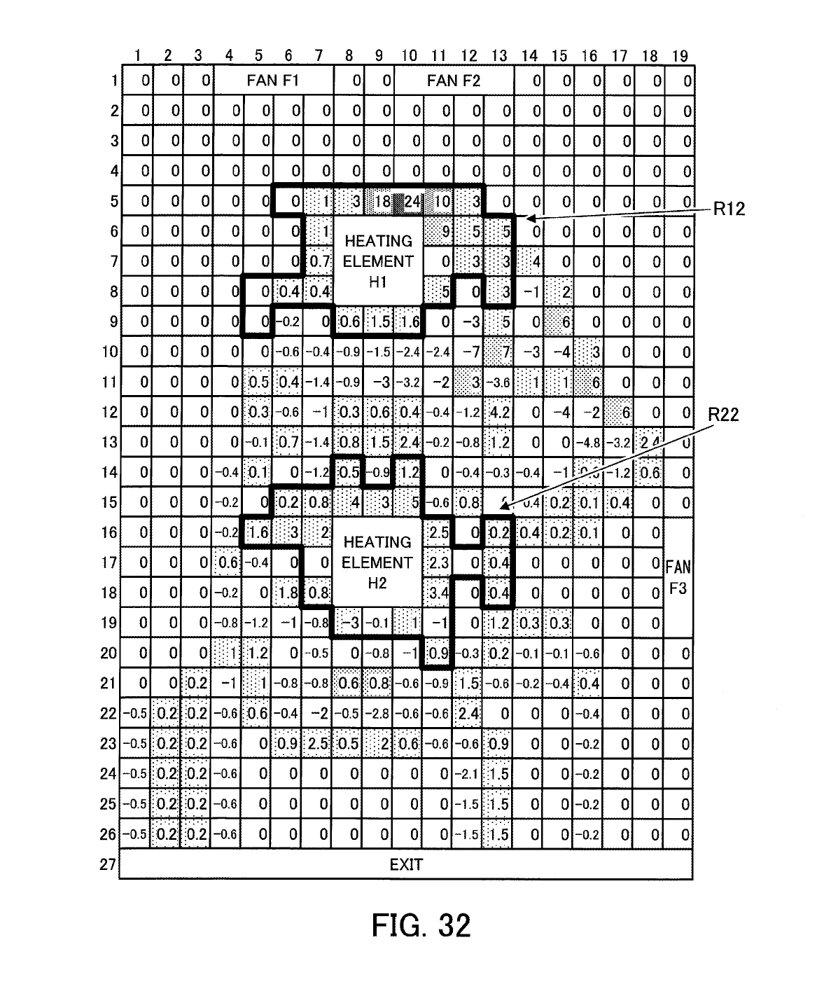

FIG. 32 illustrates a second example of the evaluation of fan-specific cooling performance. FIG. 32 exemplifies a method for evaluating the cooling performance based on the finally obtained transferred heat quantity distribution hₙ (n=fan2) associated with the fan F2. A cell range R12 corresponds to the cell range R10 and includes the same cells as the cell range R10. The cooling performance evaluating unit 120 obtains, based on the transferred heat quantity distribution hₙ (n=fan2), a sum of transferred heat quantities of all the cells included in the cell range R12, to thereby calculate the heat quantity removed from the heating element H1 by the air delivered by the fan F2.

A cell range R22 corresponds to the cell range R20 and includes the same cells as the cell range R20. The cooling performance evaluating unit 120 obtains, based on the transferred heat quantity distribution hₙ (n=fan2), a sum of transferred heat quantities of all the cells included in the cell range R22, to thereby calculate the heat quantity removed from the heating element H2 by the air delivered by the fan F2.

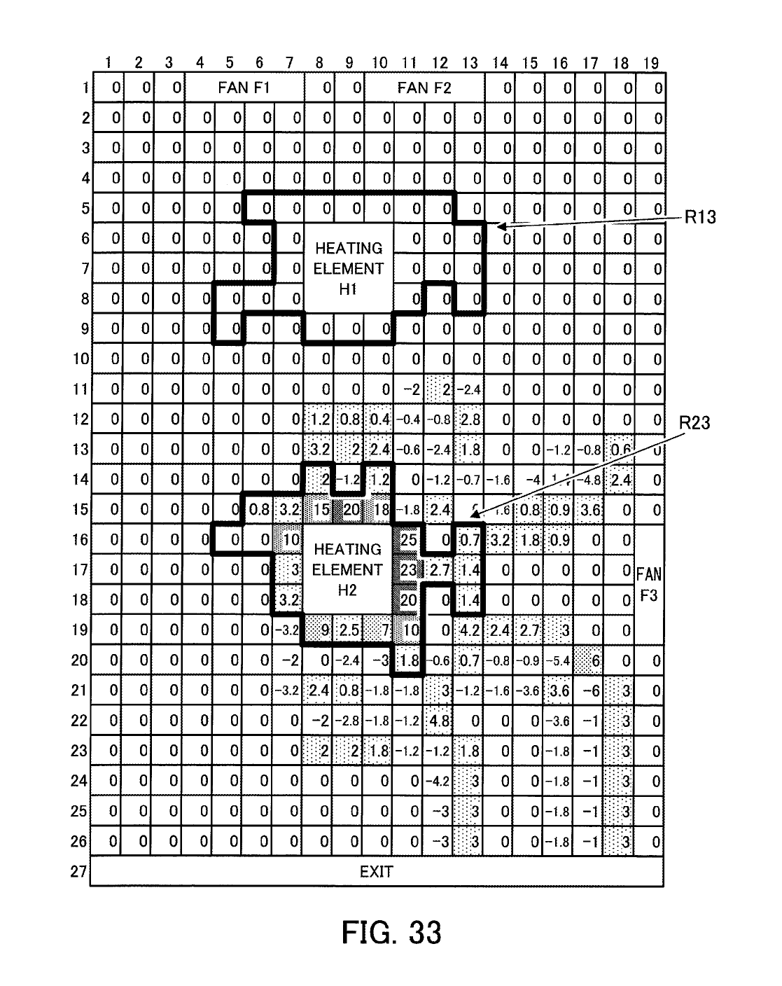

FIG. 33 illustrates a third example of the evaluation of fan-specific cooling performance. FIG. 33 exemplifies a method for evaluating the cooling performance based on the finally obtained transferred heat quantity distribution hₙ (n=fan3) associated with the fan F3. A cell range R13 corresponds to the cell range R10 and includes the same cells as the cell range R10. The cooling performance evaluating unit 120 obtains, based on the transferred heat quantity distribution hₙ (n=fan3), a sum of transferred heat quantities of all the cells included in the cell range R13, to thereby calculate the heat quantity removed from the heating element H1 by the air delivered by the fan F3.

A cell range R23 corresponds to the cell range R20 and includes the same cells as the cell range R20. The cooling performance evaluating unit 120 obtains, based on the transferred heat quantity distribution hₙ (n=fan3), a sum of transferred heat quantities of all the cells included in the cell range R23, to thereby calculate the heat quantity removed from the heating element H2 by the air delivered by the fan F3.

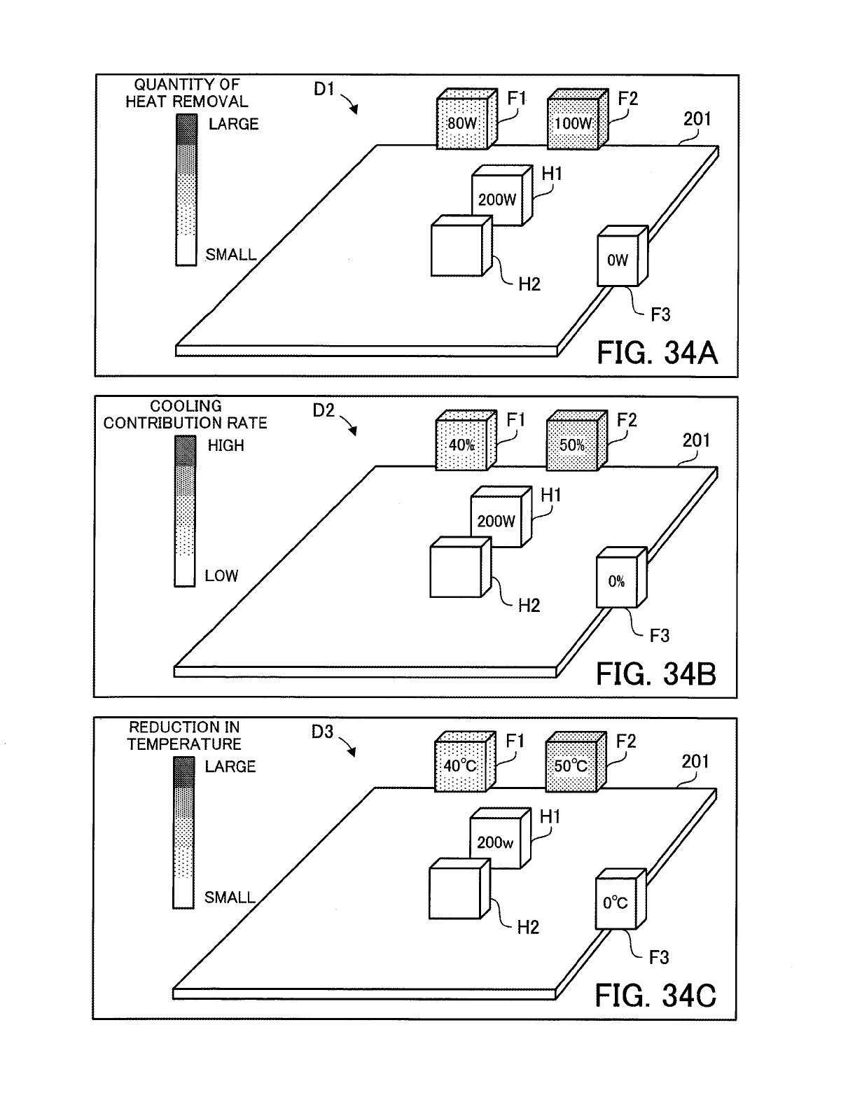

Next described are examples of how to display the degree of contribution of each fan to cooling of the heating elements H1 and H2. FIGS. 34A, 34B, and 34C illustrate a first set of display examples of evaluation results. FIG. 34A exemplifies a display screen D1. The display screen D1 displays heat quantities removed from the heating element H1 by the individual fans. For example, the cooling performance evaluating unit 120 outputs information of the display screen D1 to the display 11 to thereby cause the display 11 to display the display screen D1 (the same applies to other display screens described below). For example, when the heating power of the heating element H1 is 200 W, the cooling performance evaluating unit 120 calculates that the heat quantities removed by the air delivered by the individual fans F1, F2, and F3 are 80 W, 100 W, and 0 W, respectively. The cooling performance evaluating unit 120 may display each fan having a larger amount of heat removal in a darker shading and each fan having a smaller amount of heat removal in a lighter shading.

FIG. 34B exemplifies a display screen D2. The display screen D2 displays cooling contribution rates of the individual fans with respect to the heating element H1. For example, the cooling performance evaluating unit 120 calculates that the cooling contribution rates of the fans F1, F2, and F3 with respect to the heating element H1 are 40%, 50%, and 0%, respectively. The cooling performance evaluating unit 120 may display each fan having a higher cooling contribution rate in a darker shading and each fan having a lower cooling contribution rate in a lighter shading.

FIG. 34C exemplifies a display screen D3. The display screen D3 displays temperatures of the heating element H1 reduced by the individual fans. For example, the cooling performance evaluating unit 120 calculates that the temperatures of the heating element H1 reduced by the fans F1, F2, and F3 are 40° C., 50° C., and 0° C., respectively. These temperatures are obtained by converting the heat quantities removed by the air delivered by the individual fans of FIG. 34A into temperatures based on the mass and specific heat of the heating element H1. The cooling performance evaluating unit 120 may display each fan causing a larger temperature reduction in a darker shading and each fan causing a smaller temperature reduction in a lighter color.

In the above-described examples, the cooling performance of each fan is represented by the degree of shading, however, a different representation scheme may be used. For example, the cooling performance evaluating unit 120 may use color tones, chroma, color values, color temperature, brightness, letters representing numerical values and units, or any combination of these to represent the quantities of heat removal, the cooling contribution rates, and the magnitudes of temperature reduction.

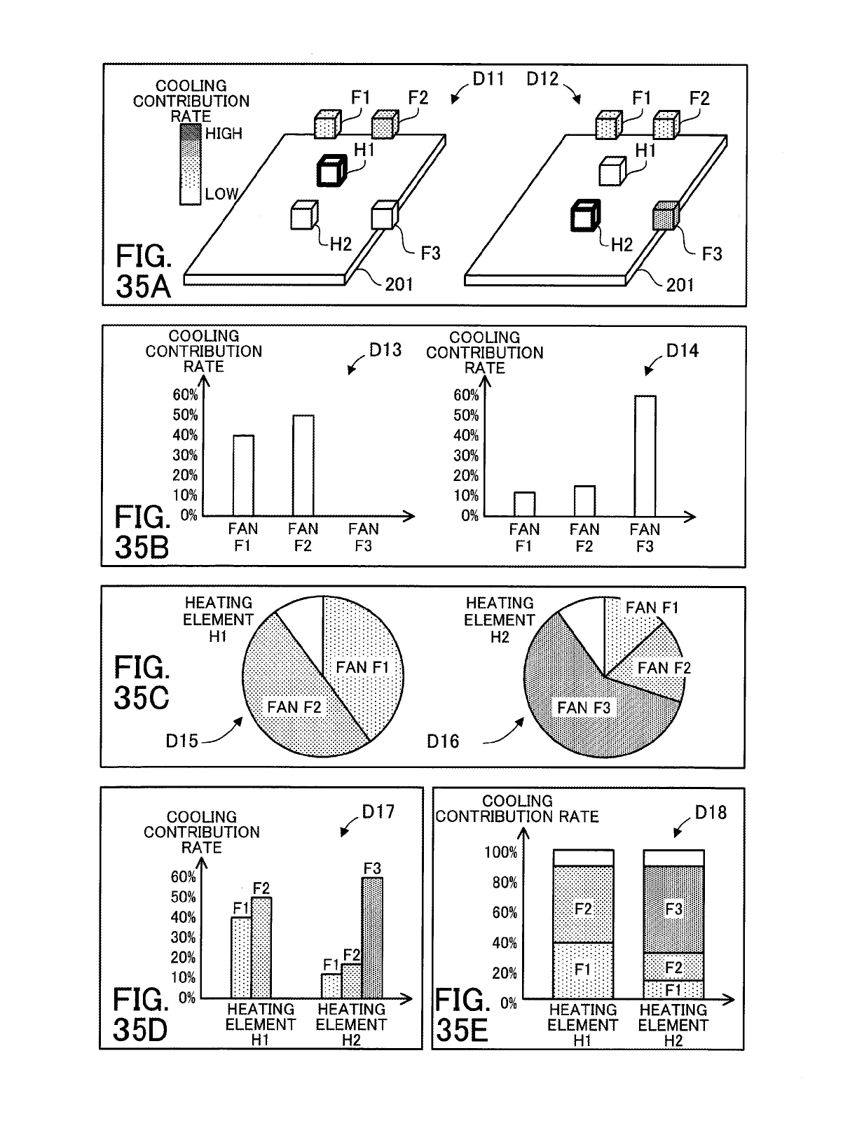

FIGS. 35A, 35B, 35C, 35D, and 35E illustrate a second set of display examples of the evaluation results. FIG. 35A exemplifies display screens D11 and D12. The display screen D11 displays cooling contribution rates of the individual fans with respect to the heating element H1. The display screen D12 displays cooling contribution rates of the individual fans with respect to the heating element H2.

FIG. 35B exemplifies display screens D13 and D14. The display screen D13 displays a bar graph representing the cooling contribution rates of the individual fans displayed on the display screen D11. The display screen D14 displays a bar graph representing the cooling contribution rates of the individual fans displayed on the display screen D12.

FIG. 35C exemplifies display screens D15 and D16. The display screen D15 displays a pie chart representing the cooling contribution rates of the individual fans displayed on the display screen D13. The display screen D16 displays a pie chart representing the cooling contribution rates of the individual fans displayed on the display screen D14.

FIG. 35D exemplifies a display screen D17, which displays compiled information containing the content of the display screens D13 and D14. FIG. 35E exemplifies a display screen D18, which displays the content of the display screen D17 in a different display format.

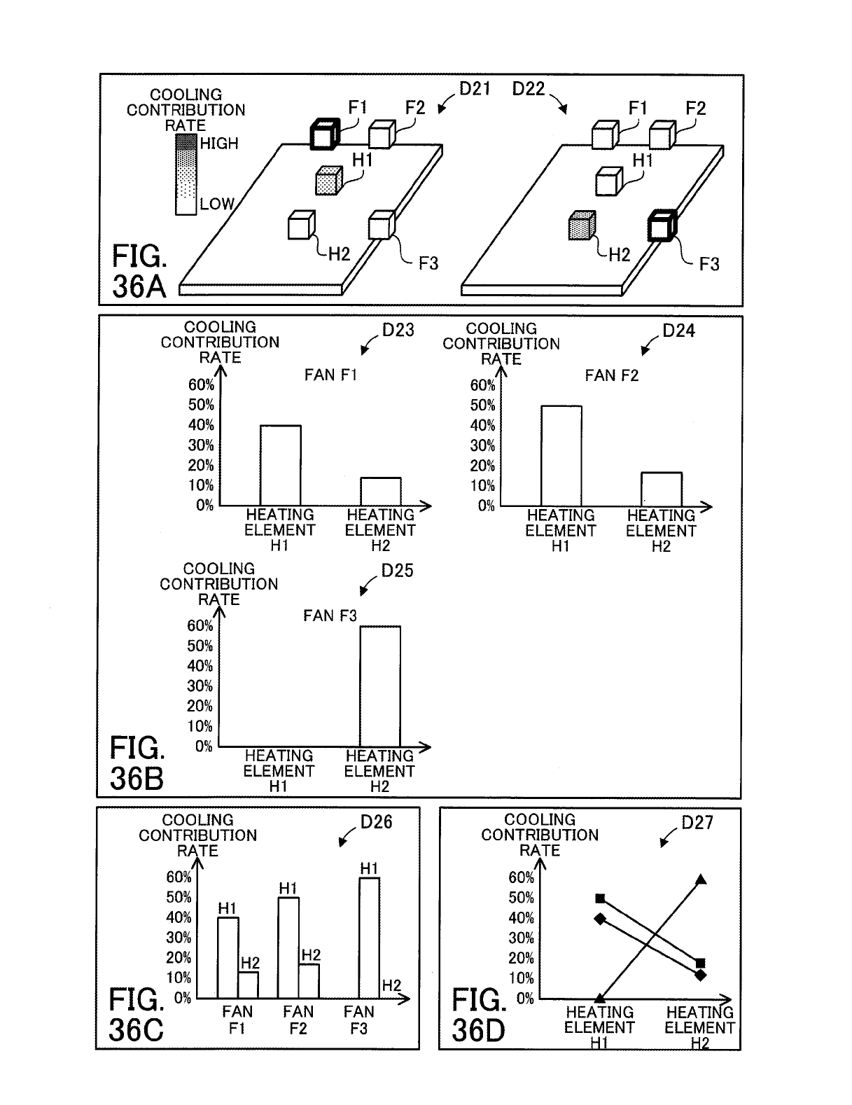

FIGS. 36A, 36B, 36C, and 36D illustrate a third set of display examples of the evaluation results. FIG. 36A exemplifies display screens D21 and D22. The display screen D21 displays cooling contribution rates of the fan F1 in relation to the heating elements H1 and H2. The display screen D22 displays cooling contribution rates of the fan F3 in relation to the heating elements H1 and H2. For example, as for each of the heating elements H1 and H2, the heating element is displayed in a darker shading if a selected fan has a higher contribution rate to cooling of the heating element, and the heating element is displayed in a lighter shading if the selected fan has a lower contribution rate to cooling of the heating element. Note however that, as mentioned above, the cooling contribution rates may be represented by a different representation scheme other than color shading, for example, color tones, chroma, color values, color temperature, brightness, or any combination of these. In addition, the cooling contribution rates of the fan F2 in relation to the heating elements H1 and H2 may be displayed in the same manner.

FIG. 36B exemplifies display screens D23, D24, and D25. The display screen D23 displays a bar graph representing the cooling contribution rates of the fan F1 in relation to the heating elements H1 and H2. Similarly, the display screen D24 displays a bar graph representing the cooling contribution rates of the fan F2 in relation to the heating elements H1 and H2. The display screen D25 displays a bar graph representing the cooling contribution rates of the fan F3 in relation to the heating elements H1 and H2.

FIG. 36C exemplifies a display screen D26, which displays compiled information containing the content of the display screens D23, D24, and D25. FIG. 36D exemplifies a display screen D27, which displays the content of the display screen D26 in a different display format.

As described above, the cooling performance evaluating unit 120 causes the display 11 to display the evaluation results of the fan-specific cooling contribution rates with respect to each of the heating elements H1 and H2. Note that the above-mentioned quantities of heat removal and magnitudes of temperature reduction are displayed in the similar fashion as to the cooling contribution rates. In addition, the cooling performance evaluating unit 120 switches display screens according to a user's operation. Further, the cooling performance evaluating unit 120 is able to cause the display 11 to display, according to a user's selection, the transferred heat quantity distributions hₙ and the potential heat quantity distributions Wₙ obtained as results of calculations.

In the manner described above, the evaluation apparatus 100 is able to support verification of the cooling performance of each of a plurality of cooling apparatuses. In conventional thermal fluid analysis, it is difficult to calculate the cooling performance of each cooling apparatus when a plurality of cooling apparatuses are made to operate in parallel. Fluids made to flow in by the plurality of cooling apparatuses blend together to create a single flow field (velocity distribution). Therefore, simply solving basic equations numerically by using the flow field only enables the evaluation of the total cooling performance of all the cooling apparatuses. That is, according to the example of the second embodiment, the conventional thermal fluid analysis allows the evaluation of, for example, the temperature distribution of the mixed air made to flow in by the fans F1, F2, and F3, however, is not able to evaluate the heat removed from each of the heating elements H1 and H2 by the inflow air delivered by the individual fans F1, F2, and F3.

On the other hand, the evaluation apparatus 100 evaluates the cooling performance of each of a plurality of cooling apparatuses with respect to a heating element and then presents the evaluation results to the user. In addition, when there are a plurality of heating elements, the evaluating apparatus 100 evaluates the cooling performance of each cooling apparatus with respect to each of the heating elements. This allows the user to perform detailed verification of the cooling performance of each cooling apparatus.

According to the example of the second embodiment, a product developer is able to verify the cooling performance of each of the fans F1, F2, and F3 by reviewing the individual screens presenting the evaluation results described above. Specifically, while adjusting the flow rates of the fans F1, F2, and F3, the product developer is able to check on the evaluation results of the cooling performance of each of the fans F1, F2, and F3 when they are made to operate in parallel, to thereby design fan-specific control (such as the operation and stop of each fan, and an increase or decrease in power consumption during the operation). In this manner, the evaluation apparatus 100 supports the user to efficiently verify the cooling performance of each of a plurality of cooling apparatuses.

In addition, the evaluation method above is effective especially in the case where a fluid delivered by a cooling apparatus is blasted by a fluid delivered by another cooling apparatus, as illustrated above.

Further, as exemplified in FIGS. 8 to 12, the above-described evaluation method uses thermal fluid analysis based on conventional CFD to obtain the velocity distribution and temperature distribution of a fluid mixture and the flow rate distributions of individual fluids. Therefore, the evaluation method has the advantage of evaluating each cooling apparatus using results obtained by the conventional thermal fluid analysis.

According to the second embodiment above, the fans F1, F2, and F3 introduce air from the outside into the chassis 200 to thereby allow the air flow into the internal space of the chassis 200. Note however that the fans F1, F2, and F3 may externally discharge air from the internal space of the chassis 200. In this case, the evaluation apparatus 100 is provided in advance with flow rate distributions indicating how much air present in the internal space of the chassis 200 is externally discharged by each of the fans F1, F2, and F3 in a steady state (flow rate distributions in relation to locations across the internal space). The evaluation apparatus 100 carries out similar calculations using these flow rate distributions in place of the distributions of FIGS. 9 to 11, to thereby evaluate the cooling performance of each fan.

Note that, as described above, the information processing of the first embodiment may be achieved by causing the calculating unit 1b to execute a program. Similarly, the information processing of the second embodiment may be achieved by causing the processor 101 to execute a program. The program may be recorded on computer-readable recording media (for example, the optical disk 13, the memory device 14, and the memory card 16).

To distribute the program, for example, portable recording media on which the program is recorded are provided. In addition, the program may be stored in a storage device of a different computer and then distributed via a network. A computer for executing the program stores, for example, in a storage device, the program which is originally recorded on a portable recording medium or received from the different computer, and then executes the program by loading it from the storage device. Note however that the computer may directly execute the program loaded from the portable recording medium or received from the different computer via the network.

In addition, at least part of the above-described information processing may be achieved by an electronic circuit, such as a DSP, an ASIC, and a PLD.

According to one aspect, it is possible to provide support for verification of the cooling performance of each of a plurality of cooling apparatuses.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A computer-readable storage medium storing a computer program for evaluating cooling performance of each of a plurality of cooling apparatuses that allows a fluid for cooling an object disposed in a space to flow into the space, the computer program causing a computer to perform a procedure comprising:
calculating, using information indicating temperatures of a fluid mixture at individual locations across the space, heat quantities transferred to the fluid mixture at the individual locations, the fluid mixture being a blend of a plurality of fluids allowed to flow in by the cooling apparatuses;
calculating heat quantities transferred to each of the fluids at the individual locations based on the heat quantities transferred to the fluid mixture at the individual locations, information indicating velocities of the fluid mixture at the individual locations, and information indicating flow rates of each of the fluids at the individual locations; and
evaluating, using the heat quantities transferred to each of the fluids at the individual locations, a degree of contribution of each of the cooling apparatuses to cooling of the object.

2. The computer-readable storage medium according to claim 1, wherein:
the calculating heat quantities transferred to each of the fluids at the individual locations includes:
obtaining a plurality of first distributions by prorating the heat quantities transferred to the fluid mixture at the individual locations according to flow ratios of each of the fluids at the individual locations,
adjusting the first distributions based on the information indicating velocities of the fluid mixture at the individual locations, and
setting the adjusted first distributions as the heat quantities transferred to each of the fluids at the individual locations.

3. The computer-readable storage medium according to claim 2, wherein:
the adjusting includes:
obtaining a plurality of second distributions indicating heat quantities stored in each of the fluids at the individual locations by plugging, into an advection equation, the information indicating velocities of the fluid mixture at the individual locations and the first distributions,
distributing the heat quantities transferred to the fluid mixture at the individual locations to a plurality of third distributions in such a manner that temperatures of the fluids at the individual locations reach the same temperature, the third distributions representing differences between each of the second distributions and a corresponding one of the first distributions, and
setting heat quantities each distributed, at each of the individual locations, to one of the third distributions as the adjusted first distributions.

4. The computer-readable storage medium according to claim 3, wherein:
the adjusting includes adjusting the first distributions until a residual error of the second distributions converges.

5. The computer-readable storage medium according to claim 3, wherein:
the procedure further comprises accepting, from a user, a selection of at least one of the first distributions and the second distributions, and presenting a display, using an apparatus for displaying an image, in such a manner that representations according to values of the individual locations in the selected distribution appear, in an image of the space, at positions corresponding to the individual locations.

6. The computer-readable storage medium according to claim 1, wherein:
the evaluating includes:
identifying a region surrounding the object,
summing the heat quantities transferred to each of the fluids at locations included in the region, and
evaluating, based on a result of the summing, the degree of contribution of each of the cooling apparatuses to cooling of the object.

7. The computer-readable storage medium according to claim 6, wherein:
the procedure further comprises outputting, with respect to each of the cooling apparatuses, information indicating at least one of the result, a ratio of the result to heating power of the object, and a temperature obtained by converting a heat quantity indicated by the result, as the degree of contribution to cooling of the object.

8. The computer-readable storage medium according to claim 7, wherein:
the procedure further comprises displaying, using an apparatus for displaying an image, an image representing the degree of contribution of each of the cooling apparatuses to cooling of the object.

9. The computer-readable storage medium according to claim 1, wherein:
the calculating heat quantities transferred to the fluid mixture at the individual locations includes obtaining a product of thermal conductivity of the fluid mixture and divergence of temperature gradient of the temperatures of the fluid mixture at individual locations across the space, to thereby calculate the heat quantities transferred to the fluid mixture at the individual locations.

10. An information processing apparatus used to evaluate cooling performance of each of a plurality of cooling apparatuses that allows a fluid for cooling an object disposed in a space to flow into the space, the information processing apparatus comprising:
a memory configured to store first information indicating temperatures of a fluid mixture at individual locations across the space, second information indicating velocities of the fluid mixture at the individual locations, and third information indicating flow rates of each of the fluids at the individual locations, the fluid mixture being a blend of a plurality of fluids allowed to flow in by the cooling apparatuses; and
a processor configured to perform a procedure including:
calculating, using the first information, heat quantities transferred to the fluid mixture at the individual locations,
calculating heat quantities transferred to each of the fluids at the individual locations based on the heat quantities transferred to the fluid mixture at the individual locations, the second information, and the third information, and
evaluating, using the heat quantities transferred to each of the fluids at the individual locations, a degree of contribution of each of the cooling apparatuses to cooling of the object.

11. A cooling performance evaluation method executed by an information processing apparatus for evaluating cooling performance of each of a plurality of cooling apparatuses that allows a fluid for cooling an object disposed in a space to flow into the space, the cooling performance evaluation method comprising:
calculating, by a processor, using information indicating temperatures of a fluid mixture at individual locations across the space, heat quantities transferred to the fluid mixture at the individual locations, the fluid mixture being a blend of a plurality of fluids allowed to flow in by the cooling apparatuses;
calculating, by the processor, heat quantities transferred to each of the fluids at the individual locations based on the heat quantities transferred to the fluid mixture at the individual locations, information indicating velocities of the fluid mixture at the individual locations, and information indicating flow rates of each of the fluids at the individual locations; and
evaluating, by the processor, using the heat quantities transferred to each of the fluids at the individual locations, a degree of contribution of each of the cooling apparatuses to cooling of the object.
